(19) United States
(12) Patent Application Publication
(10) Pub. No.: US 2025/0344693 A1
(43) Pub. Date: Nov. 13, 2025

(54) HERBICIDE SUSPENSION CONCENTRATES AND METHOD FOR THEIR PREPARATION

(71) Applicants: NUFARM AUSTRALIA LIMITED, Laverton North, Victoria (AU); UNIVERSITY OF LIVERPOOL, Liverpool (GB)

(72) Inventors: Jonathan MASSAM, Liverpool (GB); Steven Paul RANNARD, Liverpool (GB); Marco GIARDIELLO, Liverpool (GB); Andrew OWEN, Liverpool (GB); Stephen HEATON, Bradford, West Yorkshire (GB)

(21) Appl. No.: 18/860,422

(22) PCT Filed: Apr. 26, 2023
(86) PCT No.: PCT/AU2023/050340

§ 371 Date: Oct. 25, 2024

(30) Foreign Application Priority Data
Apr. 27, 2022 (AU) 2022901100

(51) Int. Cl. A01N 25/04; A01N 25/30; A01N 37/38; A01P 13/00

(52) U.S. Cl. CPC A01N 25/04; A01N 25/30; A01N 37/38; A01P 13/00

(57) ABSTRACT

A method of preparing the herbicidal carboxylic acid aqueous suspension comprising providing a liquid composition of the carboxylic acid herbicide in the form of a solution comprising a solvent for the carboxylic acid herbicide; combining the liquid composition with an aqueous phase precipitant, optionally comprising one or more of a water-soluble polymer and surfactant, under conditions of high shear mixing to cause the solution to precipitate the carboxylic acid herbicide from the solution into the aqueous phase, wherein the aqueous phase is of temperature less than the melting point of the carboxylic acid herbicide; and forming a suspension of the carboxylic acid herbicide precipitate in the aqueous phase.

### FIELD

The invention relates to suspension concentrates of carboxylic acid herbicides and methods for their preparation by precipitation and use in control of plant growth.

### BACKGROUND

Herbicidal carboxylic acids are typically water-insoluble and as a result are generally used in ester or salt forms to provide formulations for user-friendly spray application. They are typically white to brown crystalline solids of melting point over 90° C. Examples of herbicidal carboxylic acids include phenoxy carboxylic acids, aryloxy-phenoxy carboxylic acids, benzoic acids, pyridine carboxylic acids, pyridyloxy carboxylic acids, quinoline carboxylic acids, pyrimidine carboxylic acids, arylpyridine carboxylic acids and organophosphorus carboxylic acid herbicides.

Although carboxylic acid herbicides are normally formulated in the form of their salts or esters, the herbicides are typically converted to the acid form in the plant to provide herbicidal activity. Esters of the carboxylic acid herbicides are often formulated as emulsifiable concentrates but in many cases are volatile. Amine salts, on the other hand, are generally water-soluble but often have an unpleasant odour. Furthermore, many of the most useful amines used in forming salts, such as methylamine, dimethylamine and trimethylamine, have a low flash point and present significant process hazards for storage of these amines and preparation of the salts.

These drawbacks have led to attempts to formulate the carboxylic acid form of the herbicides. The acid ensures that landowners are using the least volatile product available and potentially also has additional benefits from advanced herbicide technology. It may provide enhanced uptake, increased leaf wetting and spreading, reduced spray droplet bounce and evaporation, enhanced rain fastness and pH reduction.

Emulsifiable concentrates of the carboxylic acid herbicides have been prepared using special solvents such as N,N-dimethyl octanamide as disclosed in U.S. Ser. No. 10/492,488 or concentrated modified surfactants such as described in U.S. Pat. No. 8,426,341.

The acids could potentially be formulated as aqueous suspension concentrates but attempts to do so have been met with problems of Oswald ripening resulting in the growth of crystals which may settle out from the suspension concentrates or block spray nozzles. Intense milling is generally required prior to preparing stable suspension concentrates. While milling improves the initial stability of a suspension the process is an added cost and crystallinity is still maintained during milling and leads to significant crystal growth during storage as a result of Oswald ripening. U.S. Pat. No. 6,541,426 describes a method of preparing suspension concentrates in which a melt of the pesticide, preferably in the absence of any solvent, is emulsified in an aqueous stream to form small particles that cool to form crystalline pesticide particles. The process is for pesticides of very low water solubility which do not suffer from Oswald ripening.

Attempts have been made to address Oswald ripening with the use of specialist polymers or a high loading of materials such as saccharides to stabilise the suspension. For example, the problem of Oswald ripening is addressed in US 2009/0325808 which produces a suspension concentrate by milling the acid herbicides with specific copolymers having an alternating structure intended to inhibit crystal growth. However, intense milling of the acid herbicides in preparing a mill base is required as it is desirable to reduce the particle size to less than 10 microns. Intensive milling requires special equipment and is time consuming and costly.

U.S. Pat. No. 8,541,012 describes a method of forming a suspension of insoluble pesticides preferably of solubility no more than 0.1%, more preferably no more than 0.01% which requires turbulent mixing of the pesticide solution or melt with a saccharide solution containing at least 15% by weight saccharide and especially preferred is at least 25% by weight saccharide. The two exemplified compositions use 33.3% saccharide solution and ratio of saccharide to water of 8/1 respectively. The comparative examples presented that exclude saccharide show the inability to maintain stability solely with polymeric and surfactant stabilisers. The patent does not specifically examine pesticides for which Oswald ripening is an issue.

Other researchers have addressed the poor solubility and suspension stability of herbicides such as the carboxylic acid herbicides by encapsulation in polymers by forming a coating by spray drying a polymer mixture of a particulate solution. For example, US2006/0165742 discloses a process in which a melt of the herbicide is emulsified in an aqueous composition at a temperature above the melting point and following mixing with a polymer coating material, is spray dried to form a polymer coating on the particles which is then be resuspended in water. The process involves a preliminary grinding step, melt emulsification, spray drying and re-suspension of the coated herbicide with adjuvants in order to form the suspension concentrate of encapsulated particles.

Despite the potential for formulating the highly active carboxylic acid form of the herbicides as suspension concentrates the suspension concentrates have generally been less bio-effective than the corresponding salts and esters and there are no commercially available suspension concentrates of the carboxylic acid herbicides. Further the methods used in forming suspensions are often complicated, expensive or result in crystalline formulations which are not storage stable and may block spray nozzles during spray application to weeds.

There is a need for suspension concentrates of the carboxylic acid herbicides and methods for their preparation which addresses these problems and allows concentrates of the carboxylic acid herbicides to provide effective weed control.

### SUMMARY

The suspension concentrate of the carboxylic acid herbicide is formed by precipitation of the herbicide from a liquid solution composition of the carboxylic acid herbicide comprising a solvent for the carboxylic acid herbicide. The liquid solution composition is combined with an aqueous phase, which acts as a non-solvent for the carboxylic acid herbicide, under conditions of high shear mixing to induce precipitation of particles comprising the carboxylic acid herbicide in the aqueous mixture from the liquid solution and form a suspension concentrate.

Accordingly, there is provided a method of preparing the herbicidal carboxylic acid aqueous suspension concentrate comprising
providing a liquid composition of the carboxylic acid herbicide in the form of a solution comprising a solvent for the carboxylic acid herbicide;
combining the liquid composition with an aqueous phase precipitant having a temperature less than the melting point of the carboxylic acid herbicide, under conditions of high shear mixing to cause the solution to precipitate the carboxylic acid herbicide into the aqueous phase and form a suspension concentrate from the precipitate in the aqueous phase.

The aqueous phase precipitant may, and preferably will, comprise a water-soluble polymer.

The liquid solution of the carboxylic acid herbicide preferably comprises a solvent which is non-volatile.

Accordingly, there is further provided a method for preparation of the suspension concentrate comprising:
forming a liquid solution comprising a carboxylic acid herbicide and a non-volatile solvent for the carboxylic acid herbicide;
combining the solution with an aqueous phase precipitant having a temperature less than the melting point of the carboxylic acid herbicide, under conditions of high shear mixing to cause the solution to precipitate particles of the carboxylic acid herbicide into the aqueous phase and form a suspension concentrate from the carboxylic acid precipitate.

It is preferred in order to provide a particularly stable suspension concentrate that the carboxylic acid herbicide solution is at elevated temperature when combined with the aqueous phase and the aqueous phase is at a lower temperature, typically less than the melting temperature of the herbicide and preferably in the range of 5° C. to 60° C. such as 10° C. to 50° C.

Accordingly, there is further provided a method for preparation of the suspension concentrate comprising:
providing a solution comprising a carboxylic acid herbicide and a solvent at an elevated temperature sufficient to form a hot solution of the carboxylic acid herbicide; and
combining the hot solution of the carboxylic acid herbicide with an aqueous phase precipitant at a temperature less than the melting point of the carboxylic acid herbicide under high shear to cause the solution to precipitate particles of the carboxylic acid herbicide into the aqueous phase and form a suspension concentrate of the carboxylic acid precipitate.

The hot solution comprising a carboxylic acid herbicide, when added to the aqueous phase is preferably at a temperature of from 30° C. below the melting point of the carboxylic acid herbicide to above the melting point of the herbicide, such as up to 50° C. above the melting point of the herbicide. In one embodiment the temperature of the liquid solution of the carboxylic acid herbicide is less than the melting point of a carboxylic acid herbicide dissolved therein. In contrast it is preferred that the temperature of the aqueous phase, with which the hot carboxylic acid herbicide solution is combined under shear, is no more than 60° C. such as from 5° C. to 60° C. or 10° C. to 40° C. We have also found that it is particularly advantageous if the solution of carboxylic acid herbicide is formed in a solvent, preferably a non-volatile solvent, which is a relatively poor solvent for the carboxylic acid herbicide at ambient temperature.

The solvent for the carboxylic acid herbicide may be a liquid or solid at room temperature (eg. 20° C.) and provide a liquid solvent at the temperature at which the liquid solution is added to the aqueous phase. The solvent may, for example be a further solid agrichemical active which has a melting point lower than that of the carboxylic acid herbicide and provides a solvent for the carboxylic acid herbicide in the molten state.

In a further aspect the invention provides a herbicidal suspension concentrate comprising one or more carboxylic acid herbicides. The herbicidal suspension concentrate comprises a suspension of solid particles of carboxylic acid herbicide, generally in an amount of at least 5 g/L (preferably at least 10 g/L) of suspension concentrate and a surfactant. The particles of herbicide are preferably particles are of average particle size, Dz of no more than 1 micron, preferably no more than 0.8 micron, preferably no more than 0.7 micron and still more preferably no more than 0.5 micron.

The method of the invention has an advantage of generally producing a suspension of carboxylic acid herbicide particles which have a relatively uniform particle size (i.e. small particle size distribution. It is preferred that the particles of carboxylic acid herbicide which are precipitated have a polydispersity index (PdI) of no more than 0.6 and more preferably no more than 0.5.

In a further aspect there is provided a method of controlling weeds comprising applying to the weeds or locus of the weeds a suspension concentrate comprising a suspension of solid particles of carboxylic acid herbicide in an amount of at least 5 g/L of suspension concentrate and a surfactant wherein the particles of herbicide are uncoated particles of size, D90, of no more than 2 microns. Preferably no more than 1 micron. The particles of the precipitated carboxylic acid herbicide preferably have a polydispersity index (Pdi) of no more than 0.6 and more preferably no more than 0.5. The suspension concentrate is typically applied to the weeds or locus of the weeds to be controlled following dilution of the concentrate with water. The preferred solvents include materials which are solid or liquid at ambient temperature and display a poor ability to dissolve the herbicide at ambient temperature.

### BRIEF DESCRIPTION OF DRAWINGS

Embodiments of the invention are described with reference to the attached drawings.

In the drawings:

FIG. 1 shows a scheme of a method for preparation of a suspension concentrate of a carboxylic acid herbicide in accordance with one embodiment of the invention.

FIG. 2 is a SEM photograph showing a precipitate of MCPA obtained by spraying drying the composition of Example 12. The MCPA was solvent precipitated (using a volatile solvent) and spray dried. The final material was resuspended and sprayed

FIG. 3 is a further SEM photograph of a precipitate of MCPA obtained from the method described in Example 12 at higher magnification than shown in FIG. 2.

FIG. 4 is a pXRD trace for Mecoprop-P referred to in Example 16.

FIG. 5 is a pXRD trace for MCPA referred to in Example 16.

FIGS. 6 to 9 are a series of DSC thermograms plots of normalised heat from against temperature showing the impact of heating and cooling a series of formulations of MCPA including (a) FIG. 6 showing MCPA as received from supplier; (b) FIG. 7 showing MCPA melted, cooled and remelted; (c) FIG. 8 showing MCPA hot solution in glycerol being formed, precipitated in an aqueous phase and analysed; and (d) FIG. 9 showing MCPA hot solution formed in GENAPOL X020 and then precipitated in an aqueous phase and analysed.

### DETAILED DESCRIPTION

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components, or group thereof.

Generally, the preferred carboxylic acid herbicides have a water solubility (at pH 7) of no more than 5 g/L and preferably no more than 2 g/L at 20° C. such as 0.1 g/L to 5 g/L or 0.2 g/L to 2 g/L.

The term ambient temperature where used herein, refers to temperature of the surrounding medium (or other medium and surroundings) generally in the range 0° C. to 30° C. In relation to specific solubilities the ambient temperature refers to 20° C.

The term non-volatile where used herein, refers to a material having a boiling point of at least 150° C., such as at least 200° C. (at atmospheric pressure). The non-volatile material may be a liquid or solid at ambient temperature and liquid at the temperature at which the solution is added to the aqueous phase. The non-volatile material will typically dissolve the herbicide at the temperature at which the solution is added to the aqueous phase, but the carboxylic acid herbicide may be insoluble or poorly soluble in the non-volatile materials at ambient temperature.

The term “water-soluble” as used herein means a solubility in water of at least 10 g/L, preferably at least 20 g/L such as at least 30 g/L of water at 20° C. The term “miscible” is used herein as a synonym for “soluble”, i.e., a mixture of the materials in the proportions used form a “true” solution, in which one material is molecularly dispersed in the other.

The term water-insoluble in relation to the herbicides refers to a solubility of no more than 10 g/L, preferably no more than 5 g/L at 20° C., such as no more than 2 g/L at 20C.

The precipitate which is present in the suspension concentrate is preferably predominantly amorphous. The term “predominantly amorphous” is defined as a precipitated particle formulation that shows a near complete absence of needle-like, cubic or plate-like crystal structure when observed using scanning electron microscopy, displays low intensity X-ray scattering when studied by powder X-ray diffraction techniques or exhibits reduced melting endotherms corresponding to the herbicide(s) when measured using differential scanning calorimetry. Low intensity X-ray scattering is <15%, preferably <10% and most preferably <5% of the counts that are observed from a wholly crystalline reference sample of the herbicide. Reduced melting endotherms are <15%, preferably <10% and most preferably <5% of the enthalpy observed from a wholly crystalline reference sample of the herbicide. Herbicidal particles may be isolated for microscopic observation by being sprayed onto a surface and rapid drying including freeze drying.

The particle size of the particles of the carboxylic acid herbicide in the suspension concentrate, which may be predominantly amorphous, is measured by laser diffraction and/or by light scattering. In particular, dynamic or static light scattering and laser diffraction may be used, typically using Malvern Zetasizer or Malvern Mastersizer™ instruments (e.g. Malvern Mastersizer™ 2000, available from Malvern Instruments, UK). In these laser diffraction and/or light scattering particle size measurements, preferably the particle diameter is measured or stated by volume (e.g. by stating the mean diameter by volume=the volume-weighted mean diameter) or by hydrodynamic diameter, otherwise known as the z-average or Dz. Generally, for particle size analysis, sphericity of the particles is assumed. Typically, in the present invention, the precipitated carboxylic acid herbicide particles are substantially spherical. The D_{z} of the carboxylic acid herbicide suspension concentrate formed by precipitation in accordance with the invention is typically no more than 1 micron, preferably no more than 0.8 micron and most preferably no more than 0.5 micron. For example, the carboxylic acid herbicide suspension concentrate particles may be of size Dz in the range 0.075 to 0.8 micron such as in the range 0.1 micron to 0.5 micron.

In one aspect the invention provides a herbicidal aqueous suspension concentrate comprising a solid particle suspension of at least one carboxylic acid herbicide in an amount of at least 10 g/L of suspension concentrate and a surfactant wherein the particles of carboxylic acid herbicide are of size, (D_{z}), of no more 0.5 and have a polydispersity index (PdI) of no more than 0.6, preferably no more than 0.5. Polydispersity index (PdI) is measured using a Malvern dynamic light scattering instrument (known as a Zetasizer)

The particle size of the carboxylic acid herbicides in the suspension concentrate is typically no more than 2 microns. Preferably the particles are of size (D90) of no more than 1.5 microns such as no more than 1 micron ((D90), particularly preferred are particle sizes of no more than 0.75 micron (D90) or no more than 0.5 micron. The particles are typically at least 0.075 microns such as at least 0.1 microns. It may be advantageous to select a particle size range depending on the herbicide, its use or the conditions under which it is used. Examples of various particle size ranges include 0.1-0.5 microns, 0.5-0.75 microns, 0.75-1 microns, 1-1.5 microns and 1.5-2.0 microns.

The term “precipitation” refers to the formation of particles by means of precipitation of carboxylic acid herbicide into an aqueous antisolvent from a solution of the carboxylic acid herbicide. In the present case the carboxylic acid herbicide is provided as a solution in a suitable solvent for which the aqueous phase acts as an anti-solvent. Precipitation is a process that allows the formation of dispersed particles within a medium by the rapid desolvation of the solute when a solvent solution is added to a non-solvent under conditions that prevent macroscale phase separation.

The term “adjuvant” as used herein is a broad term and is to be given its ordinary and customary meaning to a person of ordinary skill in the art (and is not to be limited to a special or customized meaning) and refers without limitation to an agent that modifies the effect of other agents and more particularly used to enhance the effectiveness of herbicides and other agents.

The term solution refers to a homogeneous mixture of a solid or solids dissolved in a liquid solvent. The carboxylic acid herbicide solute is dissolved in the solvent and in preferred embodiments the solution is free of other undissolved material.

The term carboxylic acid herbicide is used herein to refer to the herbicides in the form of the free carboxylic acid as distinct from the salts and carboxylic acid esters thereof which are normally used in formulating this group of herbicides.

The carboxylic acid herbicides include a number of herbicide chemical classes including phenoxy carboxylic acids, aryloxy-phenoxy carboxylic acids, benzoic acids, pyridine carboxylic acids, pyridyloxy carboxylic acids, quinoline carboxylic acids, pyrimidine carboxylic acids, arylpyridine carboxylic acids and organophosphorus carboxylic acid herbicides

Specific examples of carboxylic acid herbicides include:
benzoic acid herbicides selected from the group consisting of 2-methoxy-3,6-dichlorobenzoic acid (dicamba); 3,5-6-trichloro-o-anisic acid (tricamba); 3-amino-2,5-dichlorobenzoic acid (chloramben); 5-[2-chloro-4-(trifluoromethyl)phenoxy]-2-nitrobenzoic acid; 2,3,5-triiodobenzoic acid; and trichlorobenzoic acid;
phenoxy carboxylic acid herbicides selected from the group consisting of 2,4-dichlorophenoxyacetic acid (2,4-D); 4-(2,4-dichlorophenoxy)butyric acid (2,4-DB); 2-(2,4-dichlorophenoxy)propionic acid (2,4-DP); 2,4,5-trichlorophenoxyacetic acid (2,4,5-T); 2-(2,4,5-trichlorophenoxy)propionic acid; 4-chloro-2-methylphenoxyacetic acid (MCPA); 2-(4-chloro-2-methylphenoxy)propionic acid (MCPP); 4-(4-chloro-2-methylphenoxy)butyric acid (MCPB); and 2-[4-(2′,4′-dichlorophenoxy)-phenoxy]propanoic acid and including aryloxyphenoxyalkanoic acids selected from the group consisting of clodinafop, cyhalofop, diclofop, enoxaprop-P, fluazifop, haloxyfop, haloxyfop, haloxyfop-P, metamifop, propaquizafop, quizalofop-P, quizalofop-P and fenoxaprop;
pyridine carboxylic acid herbicides selected from the group consisting of 4-amino-3,5,6-trichloropicolinic acid (picloram); 3,5,6-trichloro-2-pyridyloxyacetic acid (triclopyr); 6-aryl picolinates including halauxifen, florpyrauxifen, clopyralid, aminopyralid and fluroxypyr;
quinoline carboxylic acid herbicides selected from quinclorac and quinmerac; and
organophosphorus carboxylic acid herbicides selected from glyphosate (N-(Phosphonomethyl)glycine), glufosinate (2-Amino-4-[hydroxy(methylphosphonoyl)]butanoic acid), glufosinate-P and bilanafos.

The most preferred carboxylic acid herbicides for use in the aqueous suspension concentrate of the invention and the method for preparation thereof are one or more herbicides selected from the group consisting of 2,4-D, dicamba, dichlorprop, dichlorprop-P, MCPA, mecoprop, mecoprop-P, clopyralid, fluroxypyr, glyphosate, glufosinate and glufosinate-P.

We have surprisingly found carboxylic acid herbicides may be processed by precipitation to form a suspension concentrate which is stable. The precipitate may be predominantly amorphous which is understood to significantly improve the stability of the suspension concentrate and inhibit the formation and growth of crystalline material by Oswald ripening.

The concentration of carboxylic acid herbicide precipitate in the suspension concentrate is typically at least 5 g/L, preferably at least 50 g/L, more preferably at least 100 g/L, such as at least 200 g/L, at least 300 g./L. The concentration of the precipitated carboxylic acid herbicide may be in the range 50 g/L to 700 g/L, preferably 100 g/L to 700 g/L such as 200 g/L to 700 g/L or 300 g/L to 700 g/L. One of the significant advantages of the invention is that the loading of fine particles of the suspension concentrate may be increased, for example by precipitation in the same aqueous composition (which may occur in a single vessel) over a period of time to achieve the required concentration, without any significant increase in particle size of the precipitated particles of carboxylic acid herbicide. In contrast higher loading of prior art compositions formed by intensive milling to reduce particle size generally led to crystal growth and may compromise the stability of the suspension concentrate composition, particularly on storage at low temperature such as 5° C.

The herbicidal carboxylic acid aqueous suspension concentrate typically comprises a suspension of solid particles of at least one carboxylic acid herbicide in an amount of at least 5 g/L of suspension concentrate and a surfactant wherein the particles of herbicide are uncoated and of particle diameter, D90, of no more than 2 microns, preferably D90 no more than 1 micron such as a D90 Of 0.075 micron to 1 micron or 0.075 micron to 0.75 micron.

The method of the invention allows the suspension formed by precipitation to be recirculated to progressively increase the concentration of the suspension without inducing crystal growth or unduly reducing the stability of the suspension concentrate. This is particularly advantageous as it allows a concentrate to be prepared without the need for further solvent removal or isolation and resuspension of the suspended particles by methods such as freeze drying, spray drying or the like which add significantly to the cost of manufacture. In one set of embodiments the method is conducted using a batch of aqueous phase into which the solution of carboxylic acid herbicide in gradually introduced into a zone of high shear mixing within the aqueous phase until the desired concentration is achieved. In some embodiments the aqueous phase is held in a vessel and circulated through an auxiliary vessel provided with a high shear mixer such as a rotor stator, and the solution of carboxylic acid herbicide is introduced into the aqueous phase into a zone of high shear mixing within the aqueous phase. The process of the invention may be carried out using any of these options to achieve a concentration of the carboxylic acid herbicide may be increased until the desired concentration, such as within the range 5 g/L to 700 g/L, preferably the process is conducted to 50 g/L to 700 g/L, more preferably 100 g/I to 700 g/L, still more preferably 200 g/L to 700 g/I such as 300 g/L to 650 g/L is achieved.

The suspension concentrate of carboxylic acid herbicide may be formed by precipitation of the carboxylic acid herbicide from a liquid composition of the herbicide, which may be a solution comprising a solvent by combining the liquid composition with an aqueous phase under conditions of high shear mixing.

The aqueous mixture formed by combining the aqueous phase and solution of carboxylic acid herbicide may, and preferably will, comprise a water-soluble polymer and optionally one of more surfactant. Generally, at least one of the aqueous phase and the carboxylic acid herbicide liquid solution composition will comprise a surfactant. In some cases, only the aqueous phase comprises a surfactant, in some embodiments only the solution of the carboxylic acid herbicide component will comprise a surfactant and, in some embodiments, both liquid carboxylic acid herbicide solution component and aqueous phase will comprise a surfactant.

Surprisingly, we have found that a fast precipitation process of the carboxylic acid herbicide, defined as the rapid separation of a solid particles from a good solvent environment of the carboxylic acid herbicide solution, when added under high shear mixing to a poor solvent aqueous environment, or precipitant, may occur without the substantial formation of crystalline material.

The fast precipitation leads to the creation of concentrated carboxylic acid herbicide suspensions that are stable. The good solvent environment may be created by using a solvent at ambient temperature or heating a material that may or may not have agrochemical activity and is not considered to be a good solvent at ambient temperature to a temperature where the material acts as a solvent. In a preferred embodiment the method involves heating a material that has known agrochemical activity and is not considered to be a good solvent at ambient temperature to a temperature where the material acts as a solvent for the carboxylic acid herbicide. The formation of a good solvent environment at elevated temperatures is preferably determined by the formation of a homogeneous liquid solution at a temperature below the melting point of the carboxylic acid herbicide and may be accomplished with solvents that are solid or liquid at ambient temperature.

Unlike crystallisation that is subject to Oswald ripening and instabilities that are driven by the nucleation of large structures by seed crystals, precipitation may be repeatedly undertaken in a single vessel with an increasing concentration of precipitate during the process. The method therefore provides significant advantages over melt emulsification or melt dispersion processes involving, for example, mixing streams in a confined chamber under high shear conditions and removal of solidified emulsion particles. In melt emulsification processes short residence time in the chamber is considered critical to prevent liquid formation and subsequent bulk crystallisation or aggregation of crystals into large structures. In the method of the present invention the use of solutions of the carboxylic acid herbicide overcomes the difficulties of manipulating emulsions and removes the need to manage residence time as the behaviour of crystal suspensions is overcome by forming precipitates.

The formation of a liquid solution of herbicide in a good solvent environment has surprisingly been successful when using liquids which are a poor solvent for the carboxylic acid herbicide at ambient temperature but becomes a good solvent at elevated temperature such as at least 60° C., preferably at least 70° C., more preferably at least 80° C. or using materials that are solid at ambient temperature, and therefore do not act as conventional solvents but form a liquid solvent at or above their melting point. When using a solid or a liquid that is not a solvent at ambient temperature, the material may have agrochemical activity and therefore allow for two or more agrochemicals to be simultaneously precipitated.

In one aspect the invention comprises:
dissolving at least one carboxylic acid herbicide in a water-dispersible solvent;
combining the solvent solution with an aqueous phase with high shear to precipitate particles of the herbicide and form a suspension concentrate, optionally with the addition of one or more formulation adjuvants. The solvent solution may be at a temperature suitable to dissolve the carboxylic acid herbicide and may be at a temperature less than the melting point of the carboxylic acid herbicide such as from 5° C. to 100° C.

The herbicidal aqueous suspension concentrate may be formed by precipitation of the herbicidal carboxylic acid from a hot solution in a solvent which is a solid or a poor liquid solvent for the herbicidal carboxylic acid at ambient temperature but becomes a suitable solvent at elevated temperature.

In a further embodiment the method comprises:
dissolving at least one carboxylic acid herbicide in an active non-volatile solvent which is a poor solvent at ambient temperature, at an elevated temperature sufficient to form a hot solution of the carboxylic acid herbicide, which optionally contains a surfactant and/or polymer;
combining the hot solution at a temperature less than the melting point of the carboxylic acid herbicide and an aqueous phase with high shear to precipitate particles of the herbicide in the aqueous mixture
   form a suspension concentrate of the particles of carboxylic acid herbicide, optionally with the addition of one or more formulation adjuvants.

In this embodiment the solvent may be liquid or solid at ambient temperature

In another embodiment the method comprises:
dissolving at least one carboxylic acid herbicide in an agrochemically active non-volatile solvent which is a poor solvent at ambient temperature and good solvent at a temperature below the melting point of the carboxylic acid herbicide, at an elevated temperature sufficient to form a hot solution of the carboxylic acid herbicide below the melting temperature of the carboxylic acid herbicide, which optionally contains at least a surfactant and/or polymer; and
combining the hot solution at a temperature less than the melting point of the herbicide and an aqueous phase with high shear to precipitate particles of the herbicide and form the suspension concentrate of the particles of carboxylic acid herbicide in the aqueous mixture, optionally with the addition of one or more formulation adjuvants.

In one embodiment the method provides a mixture of two or more carboxylic acid herbicides. The method may involve addition of a solution of one or more carboxylic acid herbicides in a one other carboxylic acid herbicide. For example, the solution of carboxylic acid herbicide may be formed by dissolving a first carboxylic acid herbicide in a solvent of a second carboxylic acid herbicide at a temperature at which the first carboxylic acid is a solid and the second carboxylic acid herbicide is a liquid. Alternatively, separate solutions of different carboxylic acid herbicides may be introduced sequentially or simultaneously to the aqueous phase under high shear conditions to provide a suspension concentrate comprising the mixture of the two or more carboxylic acid herbicides.

In one embodiment a solution of the carboxylic acid herbicide is formed in an additional agrochemically active component. For example, the composition may contain one, two, three or more carboxylic acid herbicides. For instance, the composition two or more carboxylic acid herbicides selected from the group consisting of 3,6-dichloro-2-methoxybenzoic acid (dicamba), 2,4-D, clomeprop; dichlorprop; dichlorprop-P, MCPA; MCPB; mecoprop; mecoprop-P; chloramben; TBA, picloram, clopyralid or aminopyralid. Specific examples of such mixtures include (a) dicamba, dichlorprop-P and 2,4-D; (b) MCPA and mecoprop-P; (c) dicamba and dichlorprop-P; (d) 2,4-D and dichlorprop-P and e) 2,4-D and mecoprop-P. Further the liquid solution may contain other materials which may be active or inert.

Examples of additional materials may include fertiliser including nitrogenous fertiliser such as such as urea, pesticides such as:
herbicides, particularly solid water-insoluble herbicides from classes other than carboxylic acid herbicides;
   fungicides;
   Insecticides;
   plant growth regulators; and
   nematicides.

Generally, the total pesticidally active component of the suspension concentrate composition will contain at least 20 wt %, preferably at least 50 wt % such as at least 70 wt % or at least 80 wt % of the total of aryl carboxylic acid and aryloxy carboxylic acid herbicides.

In one embodiment the method comprises:
forming a liquid solution composition of active components comprising the at least one carboxylic acid herbicide and optionally one or more additional active materials;
combining the liquid solution composition with an aqueous phase under high shear conditions to produce precipitation of particles of the active component; and form the suspension concentrate from the precipitate. When the active component comprises a plurality of carboxylic acid herbicides and/or other active components the liquid solution composition may have a temperature lower than the melting point of at least one carboxylic acid herbicides. Accordingly, in a preferred aspect the liquid solution composition is at a temperature lower than the melting point of the at least one carboxylic acid herbicide. This process is particularly suited to forming suspension concentrates comprising relatively high melting point carboxylic acids such as 2,4-D. which has a melting point of approx. 140.5° C., glyphosate which has a melting point of 184.5° C. and clopyralid, which has a melting point of 150° C.-154° C.

The melting points of some of the carboxylic acid herbicides which may be used in relatively high temperature solutions with solvents provided by other carboxylic acid herbicides or other pesticides is shown in Table 1 below:

TABLE 1

| Herbicide | MPt (° C.) |
|---|---|
| 2,4-D | 140.5 |
| MCPA | 114-118 |
| Dicamba | 114-116 |
| Mecoprop | 95-96 |
| Dichlorprop | 116-120 |
| Clopyralid | 150-152 |
| Picloram | 118.5 |
| Aminopyralid | 161-165 |
| Fluroxypyr | 132-133 |
| Glyphosate | 184.5 |
| Glufosinate | 230 |

The solution may comprises one or more of a first group of carboxylic acid herbicides selected from 2,4-D, clopyralid, aminopyralid and fluroxypyr and one of more of a second group of herbicides selected from arylcarboxylic acid or aryloxy carboxylic acids such as MCPA, dicamba, mecoprop, mecoprop-P, dichlorprop, dichlorprop-P, and picloram at a temperature at which the first group of herbicides is present in a solution of the second. The temperature of the composition may for example be from 100° C. to 140° C. such as from 100° to 130° C.

The herbicide composition may, for example, comprise 2,4-D and one of more herbicides selected from the group consisting of MCPA, dicamba, mecoprop, mecoprop-P, dichlorprop, dichlorprop-P and picloram at a temperature in the range of 100° C.-130° C., more preferably 2,4-D and one or more of MCPA, dicamba, mecoprop, mecoprop-P, dichlorprop and dichlorprop-P.

Specific examples of such combination may be selected from the group consisting of: 2,4-D+MCPA, 2,4-D+dicamba, 2,4-D+(mecoprop or mecoprop-P), 2,4-D+(dichlorprop or dichlorprop-P) and 2,4-D plus both dicamba and (dichlorprop or dichlorprop-P).

The suspension concentrate formed in the method may be of concentration in the range of 5 g/L to 50 g/L which is particularly suited for ready to use garden application, however it is a particular advantage of the method that it allows preparation of high loadings of carboxylic acid herbicides which are particularly useful as suspension concentrates of the carboxylic acid herbicides. In the compositions containing one or more carboxylic acid herbicides the total carboxylic acid herbicide concentration is typically at least 50 g/L, preferably at least 100 g/L, more preferably at least 300 g/L and still more preferably at least 350 g/L such as at least 400 g/L or at least 500 g/L. The concentration may be up to 750 g/L such as up to 700 g/L. Compositions containing two or three carboxylic acid herbicide may contain at least 50 g/L of each of the herbicides preferably at least 100 g/L of each of the herbicides three herbicides such as 150 g/L of each of the herbicides. The suspension concentrate may be formed at a relatively high concentration such as at least 100 g/L, preferably at least 200 g/L, more preferably at least 300 g/L and subsequently diluted to a suitable concentration for the end user such as in the range of 5 g/L to 300 g/L or 5 g/L to 200 g/L. The invention therefor provides the ability to form concentrates prior to transport, storage and handling and subsequent dilution prior to marketing and/or prior to use optionally including dilution by the end user.

The suspension concentrate may be formed by precipitation from a solution of the one or more of the carboxylic acid herbicides in a solvent. The solvent will form a solution with the carboxylic acid herbicide at the temperature at which it is to be dispersed in the aqueous phase under high shear conditions.

In one embodiment the solvent is a solvent for the carboxylic acid herbicide at room temperature. In other embodiments the solvents provide dissolution at elevated temperatures. The solvent may be selected having regard to the specific carboxylic acid herbicide composition and any further materials such as further actives present in the liquid composition of the herbicide. Examples of suitable water-soluble solvents include at least one selected from the group consisting of alcohols such as C₁ to C₄ alcohols; glycols such as C₂ to C₆ glycols particularly ethylene glycol and propylene glycol; glycerol and mono- and di-C₁ to C₁₈ aliphatic esters thereof, ketones such as acetone, organic acids such as formic and acetic acid, amides such as formamide and N,N-dimethylformamide, nitriles such as acetonitrile, esters such as such as ethyl acetate, and mono esters of glycols such as the C₁ to C₄ esters of ethylene glycol and propylene glycol; polyethers including polyalkylene glycols such as PEG 200 to PEG 1000, C₁ to C₄ alkyl ethers of ethylene glycol and diethylene glycol, C₁ to C₄ alkyl ethers of ethylene glycol and diethylene glycol, C₁ to C₄ ethers of propylene glycol and di-propylene glycol; surfactants and mixtures.

Specific examples of non-volatile solvents which may be used in forming the solution of the carboxylic acid herbicide include at least one selected from the group consisting of C₂ to C₆ glycols particularly ethylene glycol and propylene glycol; glycerol and mono- and di-C₁ to C₁₈ aliphatic esters thereof, organic acids such as formic and acetic acid, N,N-dimethylformamide, mono esters of glycols such as the C₁ to C₄ esters of ethylene glycol and propylene glycol; polyethers including polyalkylene glycols such as PEG 200 to PEG 1000, C₁ to C₄ alkyl ethers of ethylene glycol and diethylene glycol, C₁ to C₄ alkyl ethers of ethylene glycol and diethylene glycol, C₁ to C₄ ethers of propylene glycol and di-propylene glycol; surfactants such as those mentioned above and mixtures particularly fatty alcohol polyethers such as C₈ to C₁₈ fatty alcohols ethoxylated with from 2 to 15 EO units.

The method, in one set of embodiments, comprises
forming a solution of the herbicide in the non-volatile solvent at an elevated temperature to form a hot solution of the herbicide; and
combining the hot solution at a temperature less than the melting point of the herbicide with an aqueous phase having a temperature less than the melting point of the herbicide with high shear to precipitate particles of the herbicide and form a suspension concentrate optionally with addition of one or more adjuvants.

The hot carboxylic acid herbicide solution, when added to the aqueous phase may in some embodiments be at a temperature of from 40° C. below (such as from 30° C. below) the melting point of the herbicide to above the melting point of the herbicide, such as up to 50° C. above the melting point of the herbicide. In contrast it is preferred that the temperature of the aqueous phase, with which the hot herbicide solution is combined under shear, is no more than 60° C. such as from 5° C. to 50° C., 5° C. to 40° C. or 10° C. to 40° C. We have also found that it is particularly advantageous if the non-volatile solvent is a relatively poor solvent for the herbicide at ambient temperature. In general, it is preferred where a hot solution is used that the hot solution is at a temperature below the melting point of the carboxylic acid herbicide when added to the aqueous phase.

The use of a non-volatile solvent at elevated temperature has been found to be particularly effective in producing stable suspension concentrates, which may be predominantly amorphous, by rapidly providing precipitation of the carboxylic acid herbicide from the solution. Addition of the hot solution of the carboxylic acid at a temperature below the melting point of the carboxylic acid herbicide provides particularly effective precipitation of the carboxylic acid herbicide from solution.

The solution of carboxylic acid herbicide a solvent may be formed by combining molten carboxylic acid herbicide with the non-volatile liquid and cooling the mixture to below the melting point of the carboxylic acid herbicide such as at least 5° C., preferably at least 10° C., below the melting point such as 5° C. to 50° C. below the melting point such as 10° C. to 40° C. below the melting point. This process may be used to provide solvents for the carboxylic acid herbicides comprising materials which are liquid at room temperature and those which are solid at room temperature such as other lower melting point pesticides including other lower melting point carboxylic acid herbicides.

The method, in one set of embodiments, comprises forming a solution of the carboxylic acid herbicide in a surfactant and optionally additional non-volatile solvent at an elevated temperature to form a hot solution of the carboxylic acid herbicide; and
combining the hot solution at a temperature less than the melting point of the carboxylic acid herbicide with an aqueous phase with high shear mixing to precipitate particles of the carboxylic acid herbicide and form a suspension concentrate.

In some embodiments the hot carboxylic acid herbicide solution composition comprises a non-volatile solvent which is a good solvent for the herbicide component at the temperature at which the herbicide is combined with the aqueous phase, but the herbicide is a poorly soluble in the non-volatile solvent at ambient temperature. For example, the carboxylic acid herbicide may dissolve or be miscible with the non-volatile solvent at elevated temperatures and yet the carboxylic acid herbicide may have a poor solubility in the solvent at ambient temperature, such as a solubility of no more than 20 g/L such as no more than 10 g/L. In a preferred embodiment the non-volatile solvent dissolves or is miscible with the carboxylic acid herbicide at the temperature of the liquid solution of carboxylic acid herbicide which is added to the aqueous phase.

In a preferred embodiment a hot carboxylic acid herbicide solution comprises a surfactant, particularly a surfactant of HLB at least 8, preferably at least 9, more preferably 8 to 16 such as 9 to 16, 8 to 14 or 9 to 14 and optionally a non-volatile solvent selected from C₁ to C₄ esters of ethylene glycol and propylene glycol; polyethers including glycerol, polyalkylene glycols such as PEG 200 to PEG 1000, C₁ to C₄ alkyl ethers of ethylene glycol and diethylene glycol, C₁ to C₄ alkyl ethers of ethylene glycol and diethylene glycol, C₁ to C₄ ethers of propylene glycol and di-propylene glycol.

The most preferred solvents for the hot addition of the carboxylic acid herbicide solution to the aqueous phase are polyols, particularly glycerol and surfactants such as selected from the group consisting of alkoxylated fatty alcohols, alkoxylated alkyphenols, polysorbates, and poloxamers, alkoxylated fatty alkyl esters and polyoxyethylene/polyoxypropylene block copolymers.

Accordingly, in a preferred embodiment the invention provides a method for preparation of the suspension concentrate of a carboxylic acid herbicide comprising forming a solution of the carboxylic acid herbicide in a solvent selected from surfactants and water miscible polyols at an elevated temperature, preferably 70° C. to 150° C., to form a hot solution of the carboxylic acid herbicide; and
combining the hot solution with an aqueous phase, optionally comprising a polymer, under high shear to precipitate the carboxylic acid herbicide and form a suspension concentrate.

Glycerol has been found to be effective in rapidly providing a fine precipitate of the carboxylic acid herbicides to form a suspension concentrate. One of the significant advantages of polyols and particularly glycerol is that it is typically a poor solvent for the carboxylic acid herbicides at room temperature but becomes a good solvent at elevated temperature such as at least 70° C., preferably at least 80° C. Generally, the temperature of the polyol particularly glycerol is no more than 150° C., preferably no more than 130° C. and preferably less than the melting point of a dissolved carboxylic acid herbicide. Glycerol also has the significant advantage of providing antifreeze properties to the resulting suspension concentrate.

When an ambient or hot solution of the herbicide is used, it is combined with the aqueous phase to induce precipitation of the herbicide. Typically, the temperature of the aqueous phase will be lower than that of the hot solution of herbicide such as a temperature no more than 60° C. preferably no more than 50° C. such as no more than 40° C., no more than 35° C. or no more than 30° C. Typically, the temperature of the aqueous phase will be at least 5° C. preferably at least 10° C. so that generally the process can be conducted with the water at ambient temperature and without the need for heating or cooling the aqueous phase.

In one embodiment of the invention the precipitation of the liquid composition of the herbicide in the aqueous phase may be carried out 2 more times with consistent or different batches of the liquid composition of herbicide to increase the loading of the herbicide in the suspension concentrate with each batch of liquid introduced. Between the introduction of batches of the liquid herbicide composition the resulting suspension may be left, and we have found the particle size generated to be stable whether additional batches of the liquid herbicide composition are introduced to the aqueous phase. Indeed, the suspension concentrate can be stored for some time and then used as the aqueous phase to increase the loading of the suspension. Despite increases in loading particles of the same size are generated by subsequent precipitation and larger particles do not result from increase in loadings of the herbicide composition. As previously described the liquid composition added to the aqueous phase may contain two or more carboxylic acid herbicides or separate solutions of the carboxylic acid herbicides may be simultaneously or sequentially introduced to the aqueous phase.

The suspension concentrate is generally storage stable and may be stored and transported in the conventional manner without settling of the suspension. The suspension concentrate composition at the point of use may be diluted by the end user in a spray tank and applied to the weeds to be controlled or the locus of the weeds using appropriate spray equipment known in the art.

The method comprises combining the liquid composition with an aqueous phase optionally comprising a water-soluble polymer, under conditions of high shear mixing to precipitate the herbicide in the aqueous phase. The high shear condition may be provided by a range of mixers and homogenisers known in the art. The preferred conditions of high shear use a high-speed high shear mixer.

Specific examples of high speed high sheer mixers include TURRAX′.T25, SILVERSON SL2 and LV1 MICROFLUIDIZER homogenisers.

The method may be conducted by introducing the liquid solution comprising the carboxylic acid herbicide into the aqueous phase with high shear mixing until the required concentration is achieved. Alternatively, the aqueous phase may be recirculated, for example from a batch of aqueous phase, through a vessel containing a high shear mixer to allow the gradual addition of liquid solution of carboxylic acid herbicide, which may be continuous until the desired concentration is achieved. In general, the liquid solution comprising the carboxylic acid herbicide composition is preferably introduced directly into the aqueous phase adjacent to a zone of high shear mixing, for example, into the high shear zone of a rotor stator type high shear mixer.

The herbicidal aqueous suspension concentrate may comprise a water-soluble polymer. The water-soluble polymer may be added to the suspension concentrate after it has been formed or may be used in the method of the invention as part of the aqueous phase or part of the herbicide solution use in the precipitation process. Generally, it is preferred that the polymer, where used is a component of the aqueous phase into which the herbicide solution is introduced under high shear. We have found that water-soluble polymer may assist in stabilising the suspension during the high shear mixing process.

The herbicidal aqueous suspension concentrate may comprise a water-soluble polymer selected from the group consisting of:
homopolymers of or copolymers of two or more monomers selected from: vinyl alcohol, acrylic acid, methacrylic acid, acrylamide, methacrylamide, acrylamide methylpropane sulphonates, aminoalkylacrylates, aminoalkyl-methacrylates, hydroxyethylacrylate, hydroxyethylmethylacrylate, vinyl pyrrolidone, vinyl imidazole, vinyl amines, vinyl pyridine, ethyleneglycol and other alkylene glycols, ethylene oxide and other alkylene oxides, ethyleneimine, styrenesulphonates, ethyleneglycolacrylates and ethyleneglycol methacrylate.

Preferred examples of water-soluble polymers may be selected from homopolymers of or copolymers prepared from two or more monomers selected from: vinyl alcohol, acrylic acid, methacrylic acid, acrylamide, methacrylamide, acrylamide methylpropane sulphonates, aminoalkylacrylates, aminoalkyl-methacrylates, hydroxyethylacrylate, hydroxyethylmethylacrylate, vinyl pyrrolidone, vinyl imidazole, vinyl amines, vinyl pyridine, ethyleneglycol and other alkylene glycols, ethylene oxide and other alkylene oxides, ethyleneimine, styrenesulphonates, ethyleneglycolacrylates and ethyleneglycol methacrylate. In preferred embodiments the water-soluble polymer is selected from the group consisting of polyvinyl alcohol, polyvinyl pyrrolidone and polyalkylene glycols including block and random copolymers such as poloxamers, comb graft copolymers, styrene-acrylic acid copolymers, ethoxylatd copolyester copolymers such as ethoxylated acrylic and methacryic copolymers.

The number average molecular weight (Mn) of the water-soluble polymer is preferably from 5-100 kg/mol and then preferably 5-20 kg/mol.

Water-soluble polymeric thickeners such as polysaccharide gums, water-dispersible clays such as attapulgite and cellulosic materials may be used as thickeners and optionally added following suspension formation to further stabilise the suspension of the herbicide. Usually, the composition has a viscosity, at 20° C., of at most 4000 mPa·s, e.g., from 100 to 4000 mPa·s, in particular from 100 to 3000 mPa·s, determined according to ASTM D 2196 by means of a Brookfield viscosimeter.

The method includes a step of combining the liquid composition with an aqueous phase precipitant, optionally comprising a water-soluble polymer, under conditions of high shear mixing. A water-soluble polymer is preferably present in the aqueous precipitant in a weight ratio of herbicide to water-soluble polymer of 50:1 to 5:1 more preferably a weight ratio of 40:1 to 10:1. It is preferred than the water-soluble polymer selected from the homopolymers and co-polymers referred to above is present in a weight ratio of herbicide to said homopolymers or copolymers of 50:1 to 5:1 more preferably a weight ratio of 40:1 to 10:1.

The herbicidal carboxylic acid aqueous suspension concentrate will generally comprise a surfactant wherein the weight ratio of herbicide to the surfactant is in the range of from 10:1 to 2:1.

Non-limiting examples of suitable surface-active compounds are nonionic, cationic and/or anionic surfactants having good emulsifying, dispersing and wetting properties. The term “surfactants” will also be understood as comprising mixtures of surfactants.

Suitable anionic surfactants can be both water-soluble soaps and water-soluble synthetic surface-active compounds. Suitable soaps are the alkali metal salts, alkaline earth metal salts or unsubstituted or substituted ammonium salts of higher fatty acids (C₁₀-C₂₀), e.g., the sodium or potassium salts of oleic or stearic acid, or of natural fatty acid mixtures which can be obtained, e.g., from coconut oil or tallow oil. Further suitable surfactants are also the fatty acid methyltaurin salts as well as modified and unmodified phospholipids.

More frequently, however, so-called synthetic surfactants are used, especially fatty sulfonates, fatty sulfates, sulfonated benzimidazole derivatives or alkylarylsulfonates. The fatty sulfonates or sulfates are usually in the form of alkali metal salts, alkali earth metal salts or unsubstituted or substituted ammonium salts and contain a C₈-C₂₂ alkyl radical which also includes the alkyl moiety of acyl radicals, e.g., the sodium or calcium salt of lignosulfonic acid, of dodecylsulfate, or of a mixture of fatty alcohol sulfates obtained from natural fatty acids. These compounds also comprise the salts of sulfuric acid esters and sulfonic acids of fatty alcohol/ethylene oxide adducts. The sulfonated benzimidazole derivatives preferably contain 2 sulfonic acid groups and one fatty acid radical containing 8 to 22 carbon atoms. Examples of alkylarylsulfonates are the sodium, calcium or triethanolamine salts of dodecylbenzenesulfonic acid, dibutylnaphthalenesulfonic acid, or of a naphthalenesulfonic acid/formaldehyde condensation, sulfonated naphthalene-formaldehyde condensate. Also suitable are corresponding phosphates, e.g. salts of the phosphoric acid ester of an adduct of p-nonylphenol with 4 to 14 moles of ethylene oxide, cresol-formaldehyde condensate; a sulfonated cresol-formaldehyde condensate; a polycarboxylate or a derivative thereof; alkyl, a triethanolamine or potassium salt of polyarylarylethoxylate phosphate, a polyarylarylpolyoxyethylene phosphoric acid, sodium cresol-formaldehyde condensate, sodium salt of sulfonated cresol-formaldehyde condensate or a mixture thereof.

Non-ionic surfactants are preferably polyglycol ether derivatives of aliphatic or cycloaliphatic alcohols, or saturated or unsaturated fatty acids and alkylphenols, the derivatives may for example contain 3 to 30 glycol ether groups and 8 to 20 carbon atoms in the (aliphatic) hydrocarbon moiety and 6 to 18 carbon atoms in the alkyl moiety of the alkylphenols.

Further suitable non-ionic surfactants are the water-soluble adducts of polyethylene oxide with polypropylene glycol, ethylenediaminopolypropylene glycol and alkylpolypropylene glycol containing 1 to 10 carbon atoms in the alkyl chain, which adducts contain 20 to 250 ethylene glycol ether groups and 10 to 100 propylene glycol ether groups. These compounds usually contain 1 to 5 ethylene glycol units per propylene glycol unit.

Representative examples of non-ionic surfactants are nonylphenolpolyethoxyethanols, castor oil polyglycol ethers, polypropylene/polyethylene oxide adducts, tibutylphenoxypolyethoxyethanol, polyethylene glycol and octylphenoxypolyethoxyethanol. Fatty acid esters of polyoxyethylene sorbitan, e.g., polyoxyethylene sorbitan trioleate and polyoxyethylene sorbitan monolaurateare also suitable.

Cationic surfactants are preferably quaternary ammonium salts which contain, as N-substituent, at least one C₈-C₂₀ alkyl radical and, as further substituents, unsubstituted or halogenated lower alkyl, benzyl or hydroxy-lower alkyl radicals. The salts are preferably in the form of halides, methylsulfates or ethylsulfates, e.g., stearyltrimethylammonium chloride or benzyldi(2-chloroethyl)emylammomum bromide.

The preferred surfactants are non-ionic polyglycol ether derivatives of aliphatic alcohols of from 8 to 18 carbon atoms in the aliphatic group. The more preferred surfactants have an HLB in the range of 8 to 16, still more preferably 9 to 14. One example of useful surfactants is the ethoxylated fatty alcohols of 8 to 18 carbon atoms with from 2 to 15EO units. Specific examples include iso-tridecyl alcohol polyglycol ethoxylates with 2, 5, 6, 8, or 15 moles of ethoxylation Commercially available surfactants of this type include the Genapol X020, Genapol X050, Genapol X060, Genapol X080, Genapol X090, Genapol X100 and Genapol X150 respectively. The surfactants have an HLB in the range of 5 to 14. Genapol X050, Genapol X060 and Genapol X080 which include surfactants based on Isodecyl alcohol ethoxylated with 5 EO to 10 EO units and having an HLB in the range of 9 to 14.

Specific Examples of commercial sources of alkoxylated alcohols, optionally containing one or more propylene oxide units include the following surfactants:
Triton® X100 (Dow), having formula:

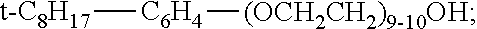

Tergitol® TMN100x (Dow), having formula:

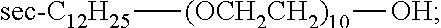

Antarox®863 (Rhodia), having formula:

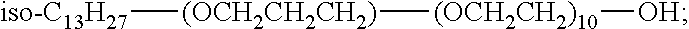

Rhodasurf®870 (Rhodia), having formula:

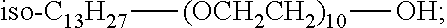

Genapol® X080 (Clariant), having formula:

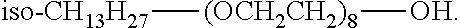

Suitable examples of polysorbate surfactants include polysorbate 20 and polysorbate 80 (sold under the Tween® brand).

The solvent for the carboxylic acid herbicide solution and the polymer in the aqueous phase may comprise in one or both components, a surfactant or mixture of surfactants optionally with additional solvent which is preferably non-volatile. In some cases, a single polymer in the aqueous phase is suitable such as such as selected from PVA, alkoxylated C₁₀ to C₁₆ fatty alcohols alkoxylated fatty-alkyl esters, polyoxyethylene/polyoxypropylene block copolymers and polysorbates. In some embodiments two or more surtactants are present as a result of mixing of the carboxylic acid herbicide solution and aqueous phase. Specific examples of such combinations include combinations of two or more surfactants selected from polysorbates (e.g. polysorbate 40, 60 or 80) such as Polysorbate 80 available under the tradename TWEEN 80, polyoxyethylene/polyoxypropylene block copolymer such as ATLOX® 4894, poloxamers such as poloxamer 188 and poloxamer 407, alkoxylated polyol esters such as available under the trade name ATPLUS® UEP and alkoxylated fatty alcohols (e.g. having fatty-aliphatic alcohol portion of from 8 to 20 carbon atoms alkoxylated with 2 to 30 oxyalkylene units). More specific examples of combinations include:
(a) mixture of Polysorbate 80 available under the tradename TWEEN 80 and alkoxylated fatty alcohol (e.g., having fatty-aliphatic alcohol portion of from 8 to 20 carbon atoms alkoxylated with 2 to 30 oxyalkylene units) such as ethoxylated isodecyl alcohol) ethoxylated with about 8 EO units (as available under the trade name GENAPOL X080);
(b) a mixture of polyoxyethylene/polyoxypropylene block copolymer such as ATLOX© 4894 and at least one of (i) alkoxylated fatty alcohol (e.g. having fatty-aliphatic alcohol portion of from 8 to 20 carbon atoms alkoxylated with 2 to 30 oxyalkylene units) such as ethoxylated isodecyl alcohol) ethoxylated with about 8 EO units (as available under the trade name GENAPOL X080), (ii) Poloxamer triblock copolymer of the form polyethylene oxide-polypropylene oxide-polyethylene oxide (PEO-PPO-PEO) such as available under the tradename Pluronic™ F-68 and (iii) Polysorbate 80 such as available under the tradename TWEEN® 80.

Typically, from 0.1 wt % % to 30 wt % of the suspension concentrate composition may be surfactant. Typically, the surfactant component will be from 0.5 wt % to 15 wt % particularly from 0.5 wt % to 10 wt % of the suspension concentrate composition.

The suspension concentrate may include a thickener which is generally added following the formation of the suspension concentrate. Suitable thickeners for the present invention include polysaccharide gums such as xanthan gum, guar gum and ethoxylated dialkyl phenols and finely divided silicates and finely divided clays such as bentonite and attapulgite. The thickener is preferably present in the composition in 0.01% to 2%, preferably 0.1% to 2% by weight such as 0.1% to 1% by weight of the suspension concentrate. The suspension concentrate may also comprise antifoam agents such as silicone antifoams. A silicone antifoam is commercially available under the Silfoam® SRE brand.

The composition of the invention does not require the presence of mono- and or di-saccharides to provide a stable suspension of the particles of aryl-carboxylic acid and/or aryloxy-carboxylic acid herbicides. The composition of the aqueous phase will generally contain no more than 5 wt % of mono- and di-saccharides, preferably no more than 1 wt % mono- and disaccharides and is preferably free of mono- and disaccharides.

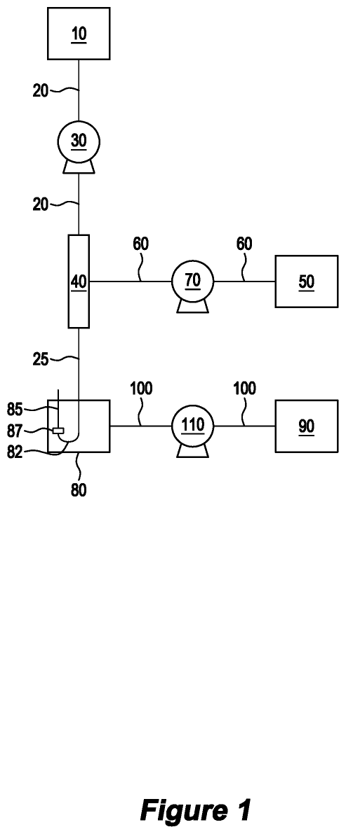

An embodiment of the invention may be described with reference to FIG. 1 of the drawings. FIG. 1 shows a schematic representation of a manufacturing method for the suspension concentrate in which a melt of a carboxylic acid herbicide component is maintained in a heated vessel (10) with stirring and transferred by pump (30) via heated transfer line (20) to maintain the molten state of the herbicide to in-line mixer (40) to produce mixing of the melt with a solvent composition comprising a solvent such as glycerol and surfactant such as a fatty alcohol ethoxylate transferred from stirred vessel (50) by transfer pump (100). The temperature of the hot solution is reduced to below the melting of the carboxylic acid herbicide as a result of mixing with the solvent composition and the hot solution is transferred via further heated transfer line (25) to precipitation vessel (80) containing a stirred aqueous phase at room temperature (such as 15° C. to 25°) containing a dissolved polymer such as PVA. The precipitation vessel is provided with a high shear mixer (85) comprising a rotor-stator high shear mixing zone (87). The Composition hot solution transfer line (25) from the in-line mixer (40) to the precipitation vessel (80) extends into or adjacent the high shear mixing zone (87) of high shear mixer (85). As a result, the hot solution is delivered from the end (82) of the transfer line (25) into the high shear mixing zone (87) to induce rapid precipitation of the carboxylic acid herbicide and form a suspension concentrate.

The concentration of the suspended carboxylic acid herbicide may be increased by continuously introducing the hot solution into the high shear zone over an extended period of time. The aqueous phase of the precipitation vessel may be supplements with adjuvants, such as one or more of polymer, surfactant and thickener contained in stirred adjuvant vessel (90) by transfer pump (110) via transfer line (100).

Despite the convenience of herbicidal suspension concentrate formulations their efficacy has generally been reported to be lower than for emulsifiable concentrates and solutions which each rely on high concentrations of powerful water immiscible solvents to solubilise the active ingredient.

For example, Xiao-xu Li et al.; J. Agric. Food Chem. 2020, 68, 1198-1206; (Fungicide Formulations Influence Their Control Efficacy by Mediating Physicochemical Properties of Spray Dilutions and Their Interaction with Target Leaves) compare the efficacy of pyraclostrobin formulations in the forms of and emulsifiable concentrate (EC), suspension concentrate (SC), and microcapsules (MCs) in the control of fungal infestations in cucumber anthracnose. The conventional SC composition used includes a broad particle size distribution and relatively large particle size. The particle size distributions of pyraclostrobin EC, MCs, and SC are reported as 0.2-1.97, 0.2-28.56, and 0.2-3.5 μm, respectively. The mean diameters of pyraclostrobin EC, SC, and MCs are reported as significantly different, being 0.91, 1.69, and 4.72 μm, respectively.

The efficacy of the compositions was tested at a range of concentrations and shown to be highly dependent on concentration of active. Across the range of concentrations, the efficacy of pyraclostrobin MCs (efficacy 87.37-95.12%) was reported to be significantly higher than those of EC (69.74-87.83%) which in turn was higher than SC (50.40-81.11%).

The paper also shows that pyraclostrobin EC and SC had significantly smaller particle sizes than pyraclostrobin MCs but crystalised on plant leaves to form larger crystals of blocklike crystallization morphology, whereas MCs remained as a sphere capsules. However, the crystal particles of pyraclostrobin SC were found to be concentrated in clusters, while those of MCs and EC were better dispersed.

The ability to form and maintain smaller particles of size (e.g 50 to 1000 nanometres, particularly 100 to 500 nanometres) in suspension concentrates of the present invention is believed to be responsible for improved efficacy and stability of the carboxylic acid herbicide suspension concentrate.

Without wishing to be bound by theory we consider the physicochemical characteristics of relatively small particles of low poly dispersity, such as dissolution kinetics, significantly reduces the propensity for Oswald ripening and also provides a significant enhancement in efficacy.

Oswald ripening is a phenomenon observed in suspension concentrates which results from the change of an inhomogeneous structure over time. Small crystals or sol particles dissolve and redeposit onto larger crystals resulting in crystal growth and poor physical stability of the suspension concentrate. The uniformity of the small particle size (small polydispersity such as less than 0.6, preferably less than 0.5 and in many cases less than 0.3) is considered to significantly reduce the problem of Oswald Ripening.

The relatively small particle size, amorphous character and low polydispersity are also considered to enhance the absorption of suspension concentrates on plant surfaces. The application to plant foliage which generally involves dilution with water and application (for example by spraying) onto plants, results in enhanced bioavailability of the carboxylic acid herbicide as a result of enhanced dissolution kinetics of small particles, particularly for particles of size less than 1 micron such as 50 to 800 or 100 to 500 nanometres commonly resulting from the process of the present invention.

Dissolution rate of the active in droplets on the surface of plant foliage is significantly enhanced for particles compositions of high surface area. The Noyes-Whitney equation states that the rate of mass transfer of solute particles into the continuous phase (rate of dissolution) is equal to: dm/dt=DACs/h. where dm/dt=rate of mass transfer/rate of dissolution. D=diffusion coefficient. A=surface area of solute particles.

Further, while diffusion occurs first through the boundary layer about particles, which may control solubility, this diffusion is very significantly enhanced for particles of size less 1 micron so that boundary layer considerations are believed to also enhance solubility and bioavailability of the carboxylic acid herbicide suspension concentrate prepared by the method of the present invention.

The suspension concentrate formed by the method of the invention has the stability to be stored and used without the need for drying and resuspension. However, in some embodiments the formation of a powder may be desirable for more concentrated storage and transport. We have found that the ‘Buchi’ B-290 type laboratory spray drying apparatus is suitable. The product form obtained from the preferred spray drying process is a powder. Generally, the suspension concentrate is prepared without the need for drying or solvent removal.

The invention will now be described with reference to an example which is provided for the purpose of further understanding embodiments of the invention but is not intended to limit the scope or applicability of the invention to the specific examples.

### EXAMPLES

Spray drying was carried out on a Buchi Mini-290 benchtop spray-dryer. For all spray drying, conditions were set as follows; 5 mL min-1 feed rate; Inlet/Outlet temperature 120/65° C., air flow volume 819 L/hr (as indicated by a 65 mm rotameter setting).

All DLS measurements were carried out using a Malvern Zetasizer Nano ZS. Unless otherwise indicated, products were dispersed at 1 mgmL⁻¹ in water and analysed twice via DLS: the first immediately after dispersion, the second after allowing the dispersion to gently roll overnight on a roller mixer.

Polyvinyl alcohol (PVA) (MW=9000-10,000, 80% hydrolysed) was obtained from Sigma-Aldrich.

High shear mixer used was a Silverson SL2.

High shear homogeniser used was an LV1 Microfluidizer.

In the high temperature precipitation section (section three), for dichlorprop-P example A the peristaltic pump used was a Masterflex L/S digital drive with a Masterflex L/S Easy-Load II pump head and with Viton Precision Pump tubing, L/S 14, using a pump speed of 100 rpm. All others used a Masterflex 07555-05 US variable speed console drive with a Masterflex L/S Easy-Load II pump head, Viton Precision Pump tubing, L/S 14 and the drive was set to approximately 300 rpm.

### Abbreviations Used

MCPP=Mecoprop-p
DP=Dichlorprop-P
SC=Suspension Concentrate.

### Example 1—Preparation of MCPA Acid SC by Precipitation from a Liquid Solution Containing MCPA, Glycerol and Surfactant

A suspension concentrate in accordance with the invention and prepared in accordance with the method of the invention uses the components shown in Table 1.

TABLE 1
The formulation BOM is this:

| Component | % w/w | |
|---|---|---|
| Water | 51.80 | |
| PVA | 2.57 | |
| Phenoxy Acid | 27.01 | =298 g/Ltr MCPA |
| Glycerol | 14.46 | |
| Genapol X050 | 3.86 | |
| Xanthan | 0.20 | |
| Proxcel GXL | 0.10 | |
| SRE Silicone Antifoam | 0.01 | |

Genapol X 050 is the nonionic surfactant Iso-tridecyl alcohol polyglycol ether with 5 EO units and which has an HLB of approx. 10

The resulting aqueous suspension concentrate composition contained 298 g/L of MCPA acid as a suspension concentrate of particle size less than 1 micron.

Low Ester/High Al Strength—Process for 1000 kgs of final product

### Preparation of Herbicide Solution for Precipitation

NaMCPA was acidified with a strong acid stock solution at ˜130° C. to give free MCPA acid melt which was washed with water to remove any water-soluble salts.

The washed MCPA acid (“phenoxy”) was combined with Genapol X050 surfactant (39 kg) with stirring and the resulting MCPA/Genapol mixture was maintained at 120-130° C. (to avoid MCPA setting).

Note: At 120° C.-130° C. the phenoxy/Genapol mixture is a low (<50 Cps) viscosity liquid with a pH of 3.0-3.5 at 20° C.

In a separate vessel Glycerol (145 kg) was mixed with water (46 kg) at room temperature, with stirring and the resulting aqueous glycerol solution was heated and maintained at ˜60° C.

### Preparation of Aqueous Phase in Dispersion Vessel

A mixture of water (400 kg) and PVA (26 kg) was prepared at room temperature, with stirring.

Silicone Antifoam (0.1 kg) was added, with stirring for at least 30 minutes minimum at room temperature to ensure the complete dispersion of the PVA charge into water.

### Dispersion of Herbicide Solution with High Shear

The phenoxy/Genapol mixture (309 kg) was force fed from the blend vessel to the dispersion vessel to mix in with the PVA/water solution (426 kg). using a linear addition rate over ˜30 minutes

As the phenoxy/Genapol mixture is fed forward it is mixed (pre-high shear mixer) in-line with the pre-heated glycerol solution (191 kg). The combined temperature of the two feeds is ˜95° C. The addition rates of the phenoxy/Genapol mixture and glycerol solution, and the line insertion point of the latter, are tuned to give a contact time between the hot phenoxy and glycerol (nominally 10 minutes). This minimises the amount of Phenoxy-Glycerol Ester formed to <0.2% w/w in the final product.

The solution of phenoxy, glycerol and surfactant mixture may be dispersed and mixed into the PVA/water solution via one of two possible plant configurations:
(i) The phenoxy/Genapol mixture is fed into an in-line mixing chamber equipped with high shear mixing, in parallel with a co-feed of PVA solution on recirculation with the dispersion vessel; and/or;
(ii) The phenoxy/Genapol/glycerol mixture is fed directly into the dispersion vessel but is directed to the suction (in-flow) side of an in-pan high shear mixer turbine (Ytron™ brand jet mixing turbine or similar) at a limited rate sufficient to prevent the melt feed bypassing the mixer head.

The resulting phenoxy dispersion batch, now at 20° C.-35° C., is stirred at room temperature for ˜30 minutes to ensure complete homogenisation. No temperature control is required at this stage.

Note: At 20-3hasC the dispersion batch has a low (<200 Cps) viscosity liquid with a pH of 3.0-3.5 at 20° C.

### Thickener—Xanthan Gel Addition

Xanthan powder (2 kg) was mixed with water (72 kg) with stirring for over 60 minutes minimum at room temperature to allow swelling of the gum in the mixture.

To the already resident phenoxy dispersion batch (926 kg) is added with stirring at room temperature (nominally 20° C.-35° C.) a 2.7% w/w Xanthan gum dispersion from the Gel vessel (74 kg).

Proxcel GXL Biocide (1 kg) is added at room temperature, with stirring. and the herbicide suspension is stirred for 30 minutes at room temperature to ensure homogeneity.

At 20° C.-35° C. the final dispersion batch is a medium (<4,000 Cps) viscosity liquid with a pH of 3.0-3.5 at 20° C.

### Example 2—Comparison of Efficacy of Example 1 MCPA Suspension Concentrate (MCPA-SC) with MCPA-Dimethyl Amine Salt (MCPA-DMA)

This example compares the Dose-Response of (116 g ae/L MELT-MCPA) against (Agritox 500 g ae/L MCPA-DMA) on seedlings at 4-leaf stage of Sinapis alba, Brassica napus, Papaver rhoeas, Plantago lanceolate in accordance with the trial matrix shown in Table 2.

TABLE 2
Trial matrix

| | Rate (g ae/ha) | | | | | | | | |
|---|---|---|---|---|---|---|---|---|---|
| | 0 | 10 | 25 | 50 | 100 | 250 | 500 | 750 | 1000 |
| UTC | Y | | | | | | | | |
| MCPA-SC | | Y | Y | Y | Y | Y | Y | Y | Y |
| MCPA-DMA | | Y | Y | Y | Y | Y | Y | Y | Y |

UTC = Untreated Control

### Materials & Methods

Treatments were applied in 100 L/ha spray volume. Spray mixtures were prepared using 1WHO water and applied as a coarse droplet size distribution using a GA110-02 nozzle at 2 Bar. All treatments were applied using a track-sprayer.

Seedlings were sown into plastic pots and maintained in a greenhouse for the duration of the experiment following treatment.

Visual assessment of % control was completed 7 days after treatment (7DAA), 14DAA & 21DAA.

Fresh weight was assessed by cutting and weighing the aerial portion of the seedling 28DAA.

### Results

Weed: Sinapis alba

Fresh weight 28DAA was reduced from 70 g for untreated controls to less than 1 g with both formulations. The results are shown in Table 3.

ANOVA Table 3. Sinapis alba- Fresh weight (g) 28DAA

| | SC | | DMAsalt | |
|---|---|---|---|---|
| UTC | 73.9 | a | | |
| UTC | 70.9 | a | | |
| 10 | 53.7 | b | 37.6 | c |
| 25 | 35.7 | c | 31.2 | c |
| 50 | 16.4 | d | 6.2 | de |
| 100 | 2.0 | e | 0.5 | e |
| 250 | 0.5 | e | 0.2 | e |
| 500 | 0.4 | e | 0.4 | e |
| 750 | 0.4 | e | 0.4 | e |
| 1000 | 0.3 | e | 0.4 | e |
| LSD P = .05 (% mean diff) | 11.099 (64%) | | | |
| Treatment Prob(F) | 0.0001 | | | |

Fresh weight Averaged across rates, the suspension concentrate of the invention was less efficacious than the corresponding MCPA-DMA salt

FAOV Table 4. Sinapis alba - Fresh
weight (g) 28DAA - Formulation

| MCPA-SC | 13.7 a |
|---|---|
| MCPA-DMA | 9.6 b |
| LSD P = .05 | 3.642 |
| Prob(F) | 0.0156 |

Weed:Brassica napus

Fresh weight 28DAA was reduced from 90 g for untreated controls to less than 3 g with bath formulations.

ANOVA Table 5. Brassica napus- Fresh weight (g) 28DAA

| | MCPA-SC | | MCPA-DMA | |
|---|---|---|---|---|
| UTC | 90.7 | ab | | |
| UTC | 96.7 | a | | |
| 10 | 85.7 | ab | 90.9 | ab |
| 25 | 94.9 | ab | 84.0 | bc |
| 50 | 67.1 | d | 72.1 | cd |
| 100 | 27.3 | e | 67.0 | d |
| 250 | 8.7 | fg | 20.7 | ef |
| 500 | 2.0 | g | 10.4 | fg |
| 750 | 1.1 | g | 7.4 | g |
| 1000 | 1.7 | g | 2.8 | g |
| LSD P = .05 (% mean diff) | 12.304 (27%) | | | |
| Treatment Prob(F) | 1E−04 | | | |

Fresh weight Averaged across rates, the suspension concentrate of the invention was more efficacious than the corresponding MCPA-DMA salt.

FAOV Table 6. Brassica napus - Fresh
weight (g) 28DAA - Formulation

| MCPA-SC | 36.06 b |
|---|---|
| MCPA-DMA | 44.42 a |
| LSD P = .05 | 4.313 |
| Prob(F) | 0.0002 |

Papaver rhoeas

Fresh weight 28DAA was reduced from 17 g for untreated controls to less than 2 g with bath formulations.

ANOVA Table 7. Papaver rhoeas- Fresh weight (g) 28DAA

| | MCPA-SC | | MCPA-DMA | |
|---|---|---|---|---|
| UTC | 20.9 | a | | |
| UTC | 17.4 | ab | | |
| 10 | 11.0 | cde | 13.0 | bc |
| 25 | 7.3 | efg | 11.9 | cd |
| 50 | 7.6 | d-g | 12.8 | c |
| 100 | 7.3 | efg | 8.7 | c-f |
| 250 | 1.1 | hi | 6.7 | efg |
| 500 | 0.0 | i | 4.5 | fgh |
| 750 | 0.0 | i | 3.5 | ghi |
| 1000 | 0.1 | hi | 1.5 | hi |
| LSD P = .05 (% mean diff) | 4.458 (60%) | | | |
| Treatment Prob(F) | 0.0001 | | | |

Fresh weight Averaged across rates, the suspension concentrate of the invention was more efficacious than the corresponding MCPA-DMA salt.

TABLE 8
FAOV Table- Papaver rhoeas - Fresh
weight (g) 28DAA - Formulation

| SC | 4.3 b |
|---|---|
| DMA salt | 7.8 a |
| LSD P = .05 | 1.514 |
| Prob(F) | 0.0001 |

Plantago lanceolate

Fresh weight 28DAA was reduced from >48 g for untreated controls to less than 2 g with both formulations.

ANOVA Table 9. Plantago lanceolata- % control 21DAA

| | MCPA-SC | | MCPA-DMA | |
|---|---|---|---|---|
| UTC | 60.0 | a | | |
| UTC | 48.9 | b | | |
| 10 | 59.3 | a | 45.4 | b |
| 25 | 40.5 | bc | 42.1 | b |
| 50 | 30.9 | cd | 24.3 | de |
| 100 | 17.7 | e | 20.9 | e |
| 250 | 5.0 | f | 2.7 | f |
| 500 | 3.5 | f | 1.9 | f |
| 750 | 1.1 | f | 1.3 | f |
| 1000 | 1.4 | f | 0.9 | f |
| LSD P = .05 (% mean diff) | 9.677 (43%) | | | |
| Treatment Prob(F) | 0.0001 | | | |

Averaged across rates, the suspension concentrate and the MCPA-DMA salt were bio-equivalent.

FAOV Table 10. Plantago lanceolata -
Fresh weight (g) 28DAA - Formulation]

| | |
|---|---|
| MCPA-SC | 19.88 - |
| MCPA-DMA | 17.42 - |
| LSD P = .05 | NS |
| Prob(F) | 0.21 |

### Conclusion

Sinapis alba is controlled with a lower dose of MCPA when applied as the DMA salt compared to the MCPA suspension concentrate
Brassica napus is controlled with a lower dose of MCPA when applied as the suspension concentrate compared to the DMA salt
Papaver rhoeas is controlled with a lower dose of MCPA when applied as the suspension concentrate compared to the DMA salt
There was no significant difference in the response to dose for either formulation on Plantago lanceolate

TABLE 11
Dose-Response Curve (Logistic) - [Data - 28DAA Fresh weight].

| | | LD10 | LD50 | LD90 |
|---|---|---|---|---|
| Sinapis alba | MCPA-SC | 5.6 | 22.7 | 92 |
| | MCPA-DMA | 2.3 | 12.9 | 74 |
| Brassica napus | MCPA-SC | 33.4 | 71.2 | 152 |
| | MCPA-DMA | 37.8 | 144.0 | 547 |
| Papaver rhoeas | MCPA-SC | 1.0 | 18.9 | 375 |
| | MCPA-DMA | 2.0 | 105.0 | 5370 |
| Plantago lanceolata | MCPA-SC | 14.1 | 55.1 | 215 |
| | MCPA-DMA | 9.3 | 55.1 | 328 |

### Example 3—Preparation of Dichlorprop-P SC by Precipitation from a Hot Dichlorprop-P Solution in Glycerol

14 g dichlorprop-P was dissolved in a mixture of glycerol, 2 g Genapol X050 and 2.4 g at approximately 115-120° C. The resulting liquid mixture was then added rapidly (through the use of a peristaltic pump) to a solution of 4 g of PVA in 80 mL of water at room temperature with rapid stirring from a high shear mixer, which resulted in the formation of a precipitate. This sample was then kept as a liquid suspension.

TABLE 12
Summary of DLS results for Section
three, DichlorpropP, Sample A.

| | | | Z-Ave after | Pdl after |
|---|---|---|---|---|
| | Initial Z-Ave | | two days | two days |
| | (nm) | Pdl | on roller mixer | on roller mixer |
| Sample A | 205 | 0.206 | 1801 | 0.159 |

### Example 4—Preparation SC Containing Particles of Comprising Mecoprop, Dichlorprop-P and 2,4-D by Precipitation from a Liquid Solution Mixture

A solution of 2,4-D (0.5 g), 0.5 g mecoprop and 0.5 g dichlorprop-P was formed at 125° C. The resulting hot liquid solution was then added via the use of a peristaltic pump to a solution of 1.2 g PVA and 0.3 g surfactant in 30 mL of water at room temperature that was being rapidly stirred using a high shear mixer, resulting in the apparent formation of a precipitate. The sample was kept as a liquid suspension with no further processing done.

This was done several times, with alternate surfactants used each time. Please refer Table 13 immediately below for details of the surfactants used.

TABLE 13
Summary of DLS results for Section four, MCPP, DP and 2, 4-D.

| | | | 24 hours on Roller | | |
|---|---|---|---|---|---|
| | Initial | | mixer | | |
| Sample code | Z-Ave (nm) | Pdl | Z-Ave (nm) | Pdl | Surfactant used |
| MCPP, DP and 2, 4-D, | 170 | 0.195 | 140 | 0.228 | Genapol X020 |
| sample A | | | | | |
| MCPP, DP and 2, 4-D, | 210 | 0.106 | 145 | 0.550 | Genapol X050 |
| sample B | | | | | |
| MCPP, DP and 2, 4-D, | 220 | 0.172 | 145 | 0.404 | Genapol X060 |
| sample C | | | | | |

### Example 5—Preparation of SC Containing Particles Including Mecoprop, Dichlorprop-P and 2,4-D by Precipitation from a Liquid Solution Mixture

0.7 g mecoprop, 0.7 g dichlorprop-P and 0.7 g 2,4-D were combined and heated to 125° C. The resulting solution was then added via the use of a peristaltic pump to the aqueous phase solution of 0.6 g PVA and 0.3 g surfactant in 18 mL of water at room temperature that was being rapidly stirred through the use of a high shear mixer, resulting in the apparent formation of a precipitate. The sample was kept as a liquid suspension with no further processing done.

This was done several times, with alternate surfactants used each time. Please refer to the Table 14 for details of the surfactants used:

TABLE 14
Summary of DLS results for Section four, MCPP, DP and 2, 4-D.

| | | | 24 hours on Roller | | |
|---|---|---|---|---|---|
| | Initial | | mixer | | |
| Sample code | Z-Ave (nm) | Pdl | Z-Ave (nm) | Pdl | Surfactant used |
| MCPP, DP and 2, 4-D, | 175 | 0.066 | 115 | 0.163 | Genapol X020 |
| Sample A | | | | | |
| MCPP, DP and 2, 4-D, | 150 | 0.116 | 145 | 0.312 | Genapol X050 |
| Sample B | | | | | |
| MCPP, DP and 2, 4-D, | 150 | 0.174 | 150 | 0.187 | Genapol X060 |
| Sample C | | | | | |
| MCPP, DP and 2, 4-D, | 140 | 0.124 | 150 | 0.339 | Genapol X080 |
| Sample D | | | | | |

Note: the normal melting point for 2,4-D on its own is approximately 145° C. whereas in this experiment a temperature of 125° C. was sufficient for all components to become liquid. This suggests that the other actives are helping to “solubilise” the 2,4-D.

### Example 6—Preparation of an SC Containing Particles Including MCPA and Mecoprop by Precipitation from a Liquid Solution Mixture

### Part A

0.75 g MCPA was dissolved in 0.75 g mecoprop at 120° C. The resulting liquid material was then added through via the use of a peristaltic pump to a solution of 1.2 g PVA and 0.3 g surfactant in 30 mL of water at room temperature that was being rapidly stirred through the use of a high shear mixer, resulting in the apparent formation of a precipitate. The sample was kept as a liquid suspension with no further processing done.

This procedure was carried out several times using a different surfactant each time. Please refer to the Table 15 immediately below for details of the surfactants used:

TABLE 15
Summary of DLS results for Section four, MCPP and MCPA, PART A.

| | | | 24 hours on Roller | | |
|---|---|---|---|---|---|
| | Initial | | mixer | | Surfactant |
| Sample code | Z-Ave (nm) | Pdl | Z-Ave (nm) | Pdl | used |
| MCPP and MCPA, Sample | 255 | 0.147 | 150 | 0.203 | Genapol X020 |
| A | | | | | |
| MCPP and MCPA, Sample | 240 | 0.141 | 155 | 0.38 | Genapol X050 |
| B | | | | | |
| MCPP and MCPA, Sample | 195 | 0.258 | 150 | 0.343 | Genapol X060 |
| C | | | | | |

### Part B

Same procedure as PART A. The aqueous phase consisted of 1.2 g PVA and 0.3 g Genapol X020 in 30 mL of water. The amount of MCPA and mecoprop used was varied for each sample. These amounts were as follows:
1.35 g MCPA, 0.15 g mecoprop (PART B, Sample A)
1.125 g MCPA, 0.375 g mecoprop (PART B, Sample B)
1 g MCPA, 0.5 g mecoprop (PART B, Sample C)
0.5 g MPA, g mecoprop (PART B, Sample D)
0.375 g MCPA, 1.125 g mecoprop (PART B, Sample E)
0.15 g MCPA, 1.35 g mecoprop (PART B, Sample F).

Samples A, B and C were heated to 125° C., all others were heated to 120° C. Samples with a higher proportion of MCPA then mecoprop generally require higher temperatures.

TABLE 16
Summary of DLS results for Section
four, MCPP and MCPA, Example B.

| | Initial | | 24 hours on Roller mixer | |
|---|---|---|---|---|
| Sample code | Z-Ave (nm) | Pdl | Z-Ave (nm) | Pdl |
| MCPP and MCPA | 450 | 0.148 | 150 | 0.218 |
| PART B, | | | | |
| Sample A | | | | |
| MCPP and MCPA | 445 | 0.359 | 160 | 0.274 |
| PART B, | | | | |
| Sample B | | | | |
| MCPP and MCPA | 350 | 0.303 | 150 | 0.244 |
| PART B, | | | | |
| Sample C | | | | |
| MCPP and MCPA | 290 | 0.209 | 170 | 0.095 |
| PART B, | | | | |
| Sample D | | | | |
| MCPP and MCPA | 280 | 0.140 | 150 | 0.127 |
| PART B, | | | | |
| Sample E | | | | |
| MCPP and MCPA | 310 | 0.230 | 170 | 0.152 |
| PART B, | | | | |
| Sample F | | | | |

### Part C

1.05 g mecoprop and 1.05 g MCPA were combined and heated to 125° C. to provide a solution. The resulting liquid material was then added via the use of a perstaltic pump to a solution of 0.6 g PVA and 0.3 g surfactant in 18 mL of water at roam temperature that was being rapidly stirred through the use of a high shear mixer, resulting in the apparent formation of a precipitate. The sample was kept as a liquid suspension with no further processing done.

This procedure was carried out several times using a different surfactant each time. Please refer to Table 17 for details of the surfactants used:

TABLE 17
Summary of DLS results for MCPP and MCPA, Example C

| | | | 24 hours on Roller mixer | |
|---|---|---|---|---|
| | Initial | | Z-Ave | |
| Sample code | Z-Ave (nm) | Pdl | (nm) | Pdl |
| MCPP and MCPA PART C, Sample | 210 | 0.125 | 155 | 0.144 |
| A | | | | |
| MCPP and MCPA PART C, Sample | 195 | 0.079 | 180 | 0.161 |
| B | | | | |
| MCPP and MCPA PART C, Sample | 190 | 0.099 | 190 | 0.317 |
| C | | | | |
| MCPP and MCPA PART C, Sample | 130 | 0.260 | 165 | 0.308 |
| D | | | | |

### Part D

Same procedure as for PART C. The aqueous layer consisted of 0.6 g PVA and 0.3 g Genapol X020 in 18 mL water. The amounts of MCPA and mecoprop varied for each individual sample as follows:
1.89 g MCPA, 0.21 g mecoprop (PART D, Sample A)
1.58 g MCPA, 0.53 g mecoprop (PART D, Sample B)
1.4 g MCPA, 0.7 g mecoprop (PART D, Sample C)
0.7 g MCPA, 1.4 g mecoprop (PART D, Sample D)
0.53 g MCPA, 1.58 g mecoprop (PART D, Sample E)
0.21 g MCPA, 1.89 g mecoprop (PART D, Sample F)

TABLE 18
Summary of DLS results for MCPP
and MCPA, Example 9 PART D.

| | | | 24 hours on | |
|---|---|---|---|---|
| | Initial | | Roller mixer | |
| | Z-Ave | | Z-Ave | |
| Sample code | (nm) | Pdl | (nm) | Pdl |
| MCPP and MCPA, PART D, | 245 | 0.228 | 135.4 | 0.260 |
| Sample A | | | | |
| MCPP and MCPA PARTD, | 245 | 0.194 | 145 | 0.197 |
| Sample B | | | | |
| MCPP and MCPA Example D, | 225 | 0.181 | 160 | 0.210 |
| Sample C | | | | |
| MCPP and MCPA PART D, | 210 | 0.104 | 145 | 0.118 |
| Sample D | | | | |
| MCPP and MCPA PART D, | 200 | 0.101 | 160 | 0.120 |
| Sample E | | | | |
| MCPP and MCPA PART D, | 230 | 0.185 | 160 | 0.159 |
| Sample F | | | | |

### Example 7—Preparation of SC Containing Particles Including Mecoprop and MCPA by Precipitation from a Liquid Solution Containing Glycerol

2.25 g Mecoprop, 2.25 g MCPA and 1.91 mL glycerol were combined and heated to approximately 115-120° C. The resulting liquid material was then added via the use of a peristaltic pump to a solution of 1.29 g PVA and 0.64 g Genapol X050 in 22.82 mL water at room temperature that was being rapidly stirred through the use of a high shear mixer, resulting in the apparent formation of a precipitate. The sample was kept as an aqueous suspension concentrate with no further processing done.

TABLE 19
Summary of DLS results for MCPP
and MCPA, Example 9 PART E

| | Initial | | 24 hours on Roller mixer | |
|---|---|---|---|---|
| Sample code | Z-Ave (nm) | Pdl | Z-Ave (nm) | Pdl |
| MCPP and MCPA, | 220 | 0.113 | 185 | 0.213 |

### Example 8—Preparation of an SC Containing Particles Including a Mixture of 2,4-D and MCPA by Precipitation from a Solution Containing Glycerol

11.81 g 2,4-D, 11.81 g MCPA, 2.23 mL glycerol and 4.05 mL water were combined and heated to approximately 125-130° C. The resulting liquid material was then added via the use of a peristaltic pump to a solution of 1.5 g PVA and 3.38 g Genapol X020 in 22.82 mL water at room temperature that was being rapidly stirred through the use of a high shear mixer, resulting in the apparent formation of a precipitate. The sample was then kept as is with no further processing done.

TABLE 20
Summary of DLS results for 2,4-D and MCPA

| | Initial | | 24 hours on Roller mixer | |
|---|---|---|---|---|
| Sample code | Z-Ave (nm) | Pdl | Z-Ave (nm) | Pdl |
| 2,4-D and MCPA, | 230 | 0.085 | 200 | 0.07 |

### Example 9—Preparation of an SC Containing Particles Including a Mixture of Dichlorprop-P, MCPA and 2,4-D by Precipitation from a Solution Containing Glycerol

1.75 g dichlorprop-P, 0.9 g MCPA and 0.73 g 2,4-D were combined and heated to approximately 125-130° C. Once fully liquid the combination of actives was added via the use of a peristaltic pump to a solution containing 0.97 g PVA and 0.48 g surfactant in 29 mL water at room temperature that was being rapidly stirred through the use of a high shear mixer, resulting in the apparent formation of a precipitate. The resulting sample was kept as a liquid suspension with no further processing done.

This procedure was carried out several times using a different surfactant each time. Please refer to the Table 21 for details of the surfactants used:

TABLE 21
Summary of DLS results for DP, MCPA and 2,4-D.

| | | | 24 hours on | | |
|---|---|---|---|---|---|
| | Initial | | Roller mixer | | |
| | Z-Ave | | Z-Ave | | Surfactant |
| Sample code | (nm) | Pdl | (nm) | Pdl | used |
| DP, MCPA and 2,4-D, | 200 | 0.137 | 215 | 0.104 | Genapol |
| Sample A | | | | | X020 |
| DP, MCPA and 2,4-D, | 215 | 0.262 | 205 | 0.130 | Genapol |
| Sample B | | | | | X050 |
| DP, MCPA and 2,4-D, | 190 | 0.258 | 225 | 0.220 | Genapol |
| Sample C | | | | | X060 |
| DP, MCPA and 2,4-D, | 200 | 0.274 | 230 | 0.188 | Genapol |
| Sample D | | | | | X080 |

### Example 10—Preparation of SC Containing Particles Including Dichlorprop-P, MCPA and Mecoprop by Precipitation from a Liquid Solution

1.75 g dichlorprop-P, 0.9 g MCPA and 0.73 g mecoprop were combined and heated to approximately 125° C. Once fully liquid the combination of actives was added via the use of a peristaltic pump to a solution containing 0.97 g PVA and 0.48 g surfactant in 29 mL water at room temperature that was being rapidly stirred through the use of a high shear mixer, resulting in the apparent formation of a precipitate. The resulting sample was kept as a liquid suspension with no further processing done.

This procedure was carried out several times using a different surfactant each time. Please refer to Table 22 for details of the surfactants used:

TABLE 22
Summary of DLS results for DP, MCPA and MCPP.

| | | | 24 hours on Roller | | |
|---|---|---|---|---|---|
| | Initial | | mixer | | |
| | Z-Ave | | Z-Ave | | Surfactant |
| Sample code | (nm) | Pdl | (nm) | Pdl | used |
| DP, MCPA and | 190 | 0.202 | 215 | 0.234 | Genapol |
| MCPP, Sample A | | | | | X020 |
| DP, MCPA and | 200 | 0.282 | 210 | 0.157 | Genapol |
| MCPP, Sample B | | | | | X050 |
| DP, MCPA and | 200 | 0.256 | 210 | 0.135 | Genapol |
| MCPP, Sample C | | | | | X060 |
| DP, MCPA and | 170 | 0.197 | 215 | 0.077 | Genapol |
| MCPP, Sample D | | | | | X080 |

### Example 11—Preparation of SC Containing Particles Including Dichlorprop-P, MCPA and Mecoprop by Precipitation from a Hot Liquid Solution Containing Glycerol

3.79 g dichlorprop-P, 1.95 g MCPA, 1.58 g mecoprop, 0.91 g glycerol and 1.25 mL water were combined and heated to approximately 115° C. Once fully liquid the solution of a combination of actives was added via the use of a peristaltic pump to a solution containing 0.97 g PVA and 1.04 g surfactant in 29 mL water at room temperature that was being rapidly stirred through the use of a high shear mixer, resulting in the apparent formation of a precipitate. The resulting sample was kept as a liquid suspension with no further processing done.

This procedure was carried out several times using a different surfactant each time. Please refer to Table 23 for details of the surfactants used:

TABLE 23
Summary of DLS results for DP, MCPA and MCPP

| | | | 24 hours on | | |
|---|---|---|---|---|---|
| | Initial | | Roller mixer | | |
| | Z-Ave | | Z-Ave | | Surfactant |
| Sample code | (nm) | Pdl | (nm) | Pdl | used |
| DP, MCPA and | 200 | 0.212 | 210 | 0.208 | Genapol |
| MCPP, Sample A | | | | | X020 |
| DP, MCPA and | 220 | 0.211 | 225 | 0.147 | Genapol |
| MCPP, Sample B | | | | | X050 |

Image 33: DLS results for Section four, DP, MCPA and MCPP, Example B (both initial and after the sample has been left to roll gently on the roller mixer overnight).

### Example 12—Formation of MCPA SC by Precipitation from an Ethanol Solution

### Example PART A

A solution of 22 g PVA in 440 mL water and another solution of 11 g of Genapol X050 in 220 mL water were combined and stirred. To this aqueous solution was added rapidly with rapid stirring a solution of 77 g MCPA in 192.5 mL ethanol, resulting in precipitation. The resulting mixture was then spray dried and the resulting powder collected to give the final product as a white solid. Amounts give a total (theoretical) solid mass of 110 g, with a mass ratio of 70% active, 20% polymer, and 10% surfactant. 74.58 g of material were successfully obtained from the collection vessel of the spray dryer (Sample A).

The above process was repeated exactly thrice more. From the first repeat 73.6 g of material was recovered from the collection vessel of the spray dryer (Sample B). From the second repeat 87.07 g of material was recovered from the collection vessel (Sample C). From the third repeat 70.97 g of material was recovered from the collection vessel (Example A, sample D).

TABLE 24
DLS results for section one, MCPA, PART A.

| | MCPA, | MCPA, | MCPA, | MCPA, |
|---|---|---|---|---|
| | Sample A | Sample B | Sample C | Sample D |
| Initial Z-Ave | 125 | 140 | 140 | 144.5 |
| Initial Pdl | 0.110 | 0.097 | 0.104 | 0.081 |
| Z-Ave Overnight | 210* | 190 | 175 | 186.6 |
| Pdl Overnight | 0.053* | 0.181 | 0.091 | 0.110 |

*= these samples were measured after being left on the roller mixer for two days instead of just overnight.

### Example Part B

4 mL of an approximately 50 mg/mL stock solution of PVA in water and 2 mL of an approximately 50 mg/mL stock solution of surfactant in water were combined and stirred. To this aqueous solution was added rapidly with stirring 1.75 mL of an approximately 400 mg/mL stock solution of MCPA in ethanol, resulting in precipitation. The resulting mixture was then spray dried and the resulting powder collected to give the final product as a white solid.

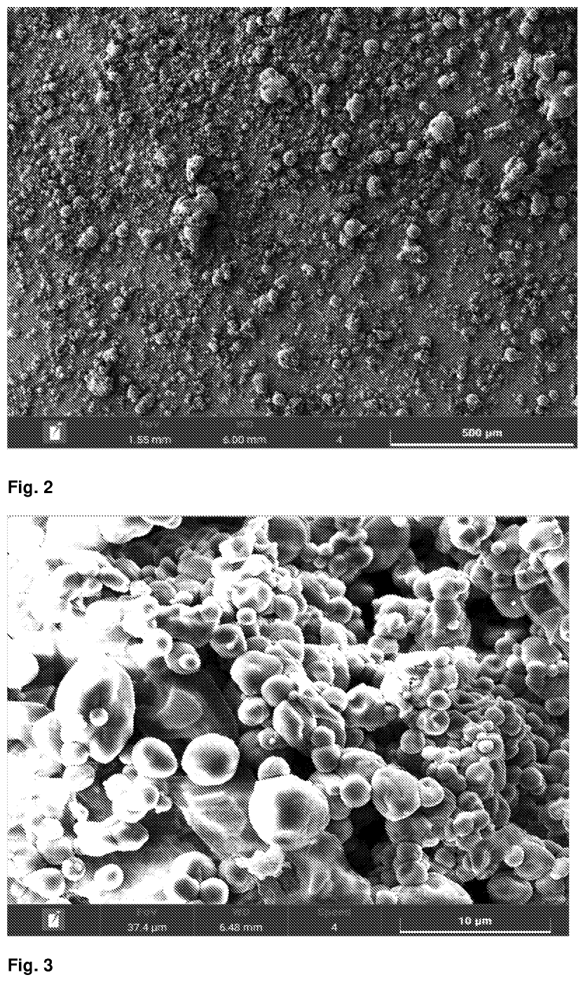

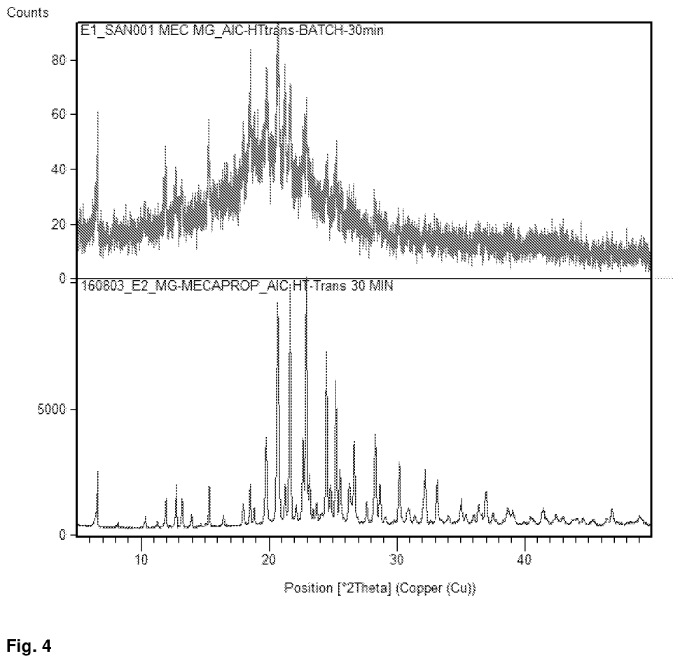

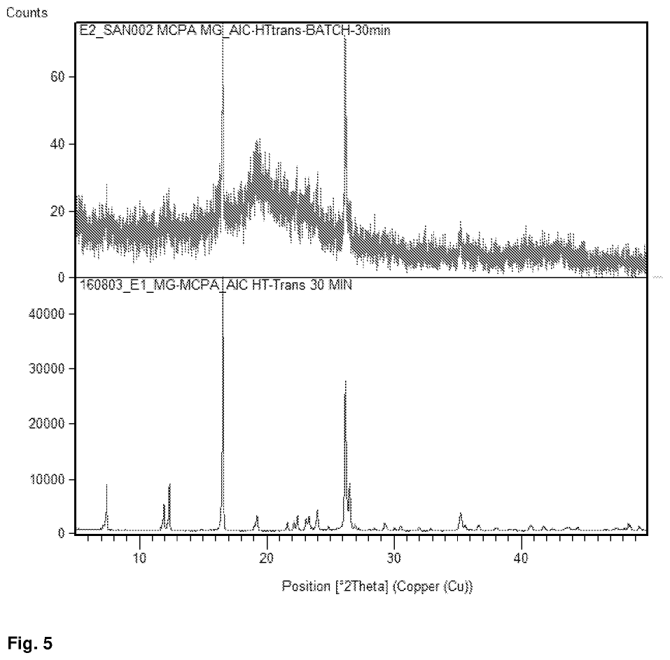

SEM images of spray dried particles shown in FIGS. 2 and 3 of the drawings. pXRD diffraction patterns are shown in FIGS. 4 and 5

Amounts give a total (theoretical) solid mass of 1 g, with a mass ratio of 70% active, 20% polymer, and 10% surfactant. Amount recovered from the spray dryer ranged from 0.44-0.45 g depending on sample. Details of the surfactant used, are shown in Table 25.

TABLE 25
Summary of DLS MCPA

| | Initial | Initial | Z-Ave | Pdl | Surfactant |
|---|---|---|---|---|---|
| Sample code | Z-Ave | Pdl | Overnight | Overnight | used |
| MCPA, PART B, | 145 | 0.070 | 215 | 0.223 | Genapol |
| Sample A | | | | | X060 |
| MCPA, PART B, | 100 | 0.143 | 180 | 0.478 | Genapol |
| Sample B | | | | | X080 |

Image 3: DLS data for section one, MCPA, Example B.

### Example 13—Preparation of a 2,4-D SC by Precipitation from an Acetone Solution

A solution of 10 g PVA in 200 mL water and another solution of 5 g of Genapol X050 in 100 mL water were combined and stirred. To this aqueous solution was added rapidly with rapid stirring a solution of 35 g 2,4-D in 87.50 mL acetone resulting in the apparent formation of a white precipitate. The resulting mixture was then spray dried and the resulting powder collected to give the final product as a white solid. Amounts give a total (theoretical) solid mass of 50 g, with a mass ratio of 70% active, 20% polymer, and 10% surfactant. 28.56 g of material was recovered from the collection vessel of the spray dryer (sample A), with a further 15.05 g obtained from the drying chamber (sample B).

TABLE 26
Summary of DLS results for section one, 2,4-D, Example A

| | Initial | Initial | Z-Ave | Pdl |
|---|---|---|---|---|
| Sample code | Z-Ave | Pdl | Overnight | Overnight |
| 2,4-D, Sample A | 130 | 0.101 | 130 | 0.221 |
| 2,4-D, Sample B | 110 | 0.186 | 150 | 0.238 |

### Example 14—Preparation of a Mecoprop SC by Precipitation from an Ethanol Solution

A solution of 5 g PVA in 100 mL water and another solution of 5 g of Genapol X060 in 100 mL water were combined and stirred. To this aqueous solution was added rapidly with stirring a solution of 40 g Mecoprop in 100 mL ethanol, resulting in precipitation. The resulting mixture was then spray dried and the resulting powder collected to give the final product as a white solid. Amounts give a total (theoretical) solid mass of 50 g, with a mass ratio of 80% active, 10% polymer, and 10% surfactant.

This exact same process was also carried out on another spray dryer at the same time. A combined total of 67.04 g of material was recovered from the collection vessels of both spray dryers (Example A, Sample A), with a further 17.36 g recovered from the drying chambers of the spray dryers (Example A, Sample B).

TABLE 27
Summary of DLS, mecoprop.

| | Initial | Initial | Z-Ave | Pdl |
|---|---|---|---|---|
| Sample code | Z-Ave | Pdl | Overnight | Overnight |
| MCPP, Sample A | 170 | 0.134 | 205 | 0.080 |
| MCPP, Sample B | 180 | 0.141 | 205 | 0.067 |

### Example 15—Preparation of a Dichlorprop-P SC by Precipitation from an Ethanol Solution

### Example PART A

A solution of 0.4 g PVA in 8 mL water and another solution of 0.1 g of surfactant in 2 mL water (surfactant detailed in Table 30) were combined and stirred. To this aqueous solution was added rapidly with rapid stirring a solution of 0.5 g Dichlorprop-P-p in 1.25 mL ethanol resulting in the apparent formation of a precipitate. The resulting mixture was then spray dried and the resulting powder collected to give the final product as a white solid. Amounts give a total (theoretical) solid mass of 1 g, with a mass ratio of 50% active, 40% polymer, and 10% surfactant. Amount collected from spray dryer ranged from 0.3 g-0.41 g depending on sample.

Note: an additional 4 mL of water was added to Sample E following precipitation as this sample had become very viscous.

TABLE 28
Summary of DLS for Dichlorprop-P.

| | Initial | Initial | Z-Ave | Pdl | Surfactant |
|---|---|---|---|---|---|
| Sample code | Z-Ave | Pdl | Overnight | Overnight | used |
| DP, PART A, | 200 | 0.169 | 115 | 0.574 | Genapol |
| Sample A | | | | | X050 |
| DP, PART A, | 185 | 0.09 | 120 | 0.528 | Genapol |
| Sample B | | | | | X060 |
| DP, PART A, | 200 | 0.107 | 210 | 0.555 | Genapol |
| Sample C | | | | | X080 |
| DP, PART A, | 175 | 0.122 | 175 | 0.580 | Genapol |
| Sample D | | | | | X090 |
| DP, PART A, | 220 | 0.224 | 140 | 0.427 | Genapol |
| Sample E | | | | | X020 |

### Example PART B

A solution of 10 g PVA in 200 mL water, another solution of 5 g of Genapol X050 in 100 mL water and an additional 50 mL water were combined and stirred. To this aqueous solution was added rapidly with rapid stirring a solution of 35 g Dichlorprop-P-p in 87.50 mL ethanol resulting in the apparent formation of a precipitate. The resulting mixture was then spray dried and the resulting powder collected to give the final product as a white solid. Amounts give a total (theoretical) solid mass of 50 g, with a mass ratio of 70% active, 20% polymer, and 10% surfactant. 38 g of material was recovered from the collection vessel of the spray dryer (Sample A), with a further 3.73 g recovered from the drying chamber (Sample B).

TABLE 29
Summary of DLS results for dichlorprop-P.

| | Initial | Initial | Z-Ave | Pdl |
|---|---|---|---|---|
| Sample code | Z-Ave | Pdl | Overnight | Overnight |
| DP, PART B, | 185 | 0.291 | 245 | 0.280 |
| Sample A | | | | |
| DP, PART B, | 215 | 0.351 | 230 | 0.182 |
| Sample B | | | | |

### Example 16—Mecoprop and MCPA Samples—Determination of Amorphous Nature of Compositions

$$\begin{matrix}Mecoprop Formulation = 50 wt \% Mecoprop - p \\ 40 wt \% Polyvinyl alcohol ( PVA ) \\ 10 wt \% Genopol X 060\end{matrix}$$

(Prepared by precipitation from hot solution in accordance with general procedure of Example 3)

$$\begin{matrix}MCPA Formulation = 30 wt \% MCPA \\ 60 wt \% Polyvinyl alcohol ( PVA ) \\ 10 wt \% Genopol X 060\end{matrix}$$

(Prepared by precipitation from hot solution in accordance with general procedure of Example 3)

Samples were analysed via DLS following addition of water. DLS analysis was taken immediately. The dispersion was then rolled for 24 hrs and DLS analysis was repeated. The particle size determination results are shown in Table 30.

TABLE 30

| | |
|---|---|
| Immediate Dispersion | 24 hrs Dispersion |

| | Z-Ave | PDI | Z-Ave | PDI |
|---|---|---|---|---|
| Mecoprop | 160 | 0.17 | 220 | 0.12 |
| MCPA | 120 | 0.16 | 130 | 0.42 |

All DLS run at 1 mg/ml in water at 25° C. with respect to active content.

pXRD Traces for (A) Mecoprop-p and (B) MCPA are sown in FIGS. 4 and 5 respectively. The top plots show. Red shows the formulated powder from the suspension concentrate, the lower plots show powders as received. The plots provide evidence of significant amorphous character of the particles in the suspension concent5rate.

MCPA pXRD shows very little crystalline nature (predominantly amorphous) to the freeze-dried material, confirming the studies of spray dried samples above

Example 17—SC prepare by precipitation of Dichlorprop-P, 2,4-D and Dicamba. All DLS measurements were carried out using a Malvern Zetasizer Nano ZS. Products were dispersed at 1 mgmL⁻¹ in water and analysed twice via DLS: the first immediately after dispersion, the second after allowing the dispersion to gently roll overnight on a roller mixer.

Polyvinyl alcohol (PVA) (MW=9000-10,000, 80% hydrolysed) was obtained from Sigma-Aldrich.

High shear mixer used was a Silverson SL2.

Peristaltic pump used was a Masterflex 07555-05 L/S variable speed console drive with a Masterflex L/S Easy-Load II pump head, Viton Precision Pump tubing, L/S 14 and the drive was set to approximately 80 mL/min

3.80 g dichlorprop-P, 1.91 g 2,4-D and 1.91 g dicamba were combined with 1.08 g surfactant, 0.72 mL glycerol and 0.98 mL water. This combination was then heated to approx. 125° C. and the resulting liquid material was then added via peristaltic pump to a solution of 0.97 g PVA in 29 mL water that was being rapidly stirred at room temperature by a high shear mixer resulting in the apparent formation of a precipitate. The sample was kept as a liquid suspension with no further processing done.

This procedure was carried out twice using a different surfactant each time. Please refer to the Table 31 below for details of the surfactants used:

TABLE 31
Summary of DLS data for the combination of dichlorprop-P,
2,4-D and dicamba, samples A and B

| | | | 24 hours on | | |
|---|---|---|---|---|---|
| | Initial | | Roller mixer | | |
| | Z-Ave | | Z-Ave | | Surfactant |
| Sample code | (nm) | Pdl | (nm) | Pdl | used |
| Dichlorprop-P, 2,4-D and | 140 | 0.344 | 150 | 0.142 | Genapol |
| dicamba combination, | | | | | X050 |
| Sample A | | | | | |
| Dichlorprop-P, 2,4-D and | 140 | 0.175 | 190 | 0.078 | Genapol |
| dicamba combination, | | | | | X060 |
| Sample B | | | | | |

### Example 18—PART a Dichloroprop, 2,4-D and Dicamba Mixed Active Dispersion Precipitation

This procedure provides a suspension concentrate containing 103.4 g/L of dichloroprop-P, 51.98 g/L 2,4-D and 51.98 g/L dicamba

Polyvinyl alcohol, PVA, (0.97 g) was dissolved in H₂O (29 mL) to provide an aqueous phase. Dichloroprop-P (3.8 g), 2,4-D (1.91 g) and dicamba (1.91 g) were added to a 40 mL vial along with Genapol X050 (1.08 g), glycerol (0.91 g) and H₂O (0.98 mL). The mixture of solids was then heated to 140° C. until this resulted in a homogeneous liquid. Simultaneously rubber tubing (Viton Precision Pump tubing, L/S 14) was also heated on a hotplate having a temperature of 140° C. using a hotplate and Asynt heating insert. Antifoam, Silfoam SRE (2-3 drops, 111.1 mg mL⁻¹) was added to the PVA/H₂O mixture before being stirred using a Silverstone SL2 high sheer mixer. Once fully mixed the hot solution of actives was pumped at a temperature of 115° C. into the ambient temperature PVA/H₂O mixture using a peristaltic pump to provide precipitation from a dispersion at a DLS characterisation was undertaken on samples diluted to 1 mg/mL in H₂O after synthesis and 24 hours after.

### Example 18—Part B

The procedure of Part A repeated with the exception that the surfactant Genapol X050 was replaced with Gelapol X060. (Genapol X050 and Gelapol X060 are iso-tridecyl alcohol polyglycol ethoxylates with 5, 6, moles of ethoxylation respectively).

### Example 19—Suspension Concentrate Containing 198.33 g/L Dichlorprop-P, 99.75 g/L 2,4-D and 99.75 g/L Dicamba

The procedures of Examples 18 Part A and 18 Part B were used to prepare the higher concentrations of respective herbicides.

The DLS results for Examples 18 and 19 are shown in Table 32.

| | Ex 18A | Ex 19B | Ex 19A | Ex 19B |
|---|---|---|---|---|
| | (Genapol | (Genapol | (Genapol | (Genapol |
| | X050) | X060) | X050) | X060) |
| Initial Z-Ave | 140 | 140 | 125 | 130 |
| Initial Pdl | 0.344 | 0.175 | 0.271 | 0.320 |
| Overnight Z- | 150 | 190 | 165 | 155 |
| Ave | | | | |
| Overnight Pdl | 0.142 | 0.078 | 0.175 | 0.129 |

### Example 20—PVA Molecular Weight Comparisons

In a procedure comparing the effects of PVA molecular weight, targeting a MCPA concentration of 106 g/L with a 70: 20: 10% active to polymer to surfactant ratio, 3 PVA materials were selected; VWR 500-5000 g mol⁻¹, Selvol 103 and Selvol 203S. The chosen PVA (0.714 g) was dissolved in H₂O (14.28 mL, 50 mg mL⁻¹). Simultaneously Genapol X050 (0.357 g) was dissolved in H₂O (7.14 mL, 50 mg mL⁻¹) and both solutions were mixed overnight. MCPA (2.5 g) was weighed into a 40 mL vial along with glycerol (1.351 g) and then heated to 110° C. using a hotplate and Asynt heating insert to prepare a solution. Solutions of PVA and Genapol X050 were combined and antifoam Silfoam SRE (2-3 drops, 111.1 mg mL-) was added. The polymer/surfactant mixture was stirred using a Silverstone SL2 high sheer mixer before the solution of MCPA was pumped in to the ambient temperature aqueous phase using a peristaltic pump. DLS characterisation was undertaken on samples diluted to 1 mg/mL in H₂O after synthesis and 24 hours after.

All PVA sample provided a suitable product but lower molecular weight 500 to 10,000 g/mol and particularly 500 to 5000 g/mol were particularly useful.

The results for different PVA composition are shown in Table 33.

TABLE 33

| | |
|---|---|
| D_{z} | Pdl |

| | | Over- | | Over- |
|---|---|---|---|---|
| Sample | Day 1 | night | Day 1 | night |
| PVA | 320 | 255 | 0.118 | 0.111 |
| VWR | 235 | 120 | 0.075 | 0.297 |
| Selvol 203S | 240 | 190 | 0.079 | 0.064 |

### Example 21—Polymer/Surfactant Combinations (Single Active)

The procedure of Example 20 may be carried out in which PVA (polymer) and Genapol X050 surfactant are interchanged with the respective combinations shown in Table 34 and using a weight ratio of active:polymer:surfactant of, for example 70:20:10. In the process a hot solution of Active carboxylic acid herbicide in the surfactant is mixed with high shear into an aqueous solution of the polymer.

### Part-A

TABLE 34
Using MCPA as the Active

| Sample | | |
|---|---|---|
| Number | Polymer | Surfactant |
| 1 | Pluronic F68 | Genapol X050 |
| 2 | Atlox Metasperse 550S | Genapol X050 |
| 3 | Atlox Metasperse 550S | Tween 22 |
| 4 | Pluronic F68 | Tween 24 |
| 5 | Atlox Metasperse 550S | Tween 24 |
| 6 | Atlox Metasperse 550S | Synperonic PE/L 64 |
| 7 | Pluronic F127 | Atlox 4914 |

Atlox Metasperse ® 550S is an anionic polymeric dispersant hydrophobized sodium salt of styrene acrylic. polymer available from Croda Cropcare.
Pluronic ® F68 and Pluronic ® F127 are poloxamers.
Tween ® 22 is an ethoxylated (PEG-80) sorbitan monolaurate
Tween 24 is an ethoxylated sorbitan ester of HLB about 17
Atlox ® 4914 is an ethoxylated alkyd copolyester resin.available from Croda Cropcare
Atlox ® 4916 is a Polymeric Ester Dispersant available from Croda Cropcare

The particle size arising from the different combination is shown in Table 35.

| | |
|---|---|
| D_{z} (nanometres) | Pdl |

| Sample | Day 1 | Over-night | Day 1 | Over-night |
|---|---|---|---|---|
| 1 | 205 | 120 | 0.258 | 0.349 |
| 2 | 45 | 40 | 0.335 | 0.335 |
| 3 | 100 | 75 | 0.285 | 0.450 |
| 4 | 140 | 155 | 0.210 | 0.120 |
| 5 | 80 | 85 | 0.350 | 0.418 |
| 6 | 130 | 130 | 0.228 | 0.231 |
| 7 | 795 | 395 | 1.000 | 0.700 |

### Part B Using Mecoprop as the Active

Mecoprop was formed into a suspension concentrate of concentration 198 g/L in accordance with the general procedure of Example 20 using PVA as the polymer and the surfactants shown in the following Table to provide a suspension concentrate having the particle size (D_{z} nanometres) and polydispersity shown in Table 36

TABLE 36

| | |
|---|---|
| D_{z} (nm) | Pdl |

| Sample-surfactant | Day 1 | 24 hrs | Day 1 | 24 hrs |
|---|---|---|---|---|
| A -Genapol X020 | 215 | 180 | 0.159 | 0.273 |
| B - Genapol X050 | 140 | 220 | 0.196 | 0.322 |
| C - Genapol X060 | 130 | 220 | 0.189 | 0.341 |
| D -Genapol X080 | 160 | 470 | 0.314 | 0.516 |

### Part C—Using Dichlorprop-P as the Sole Active

Dichlorprop-P was formed into a suspension concentrate of concentration 108 g/Lin accordance with the general procedure of Example 20 using PVA as the polymer and the surfactants shown in the following Table to provide a suspension concentrate having the particle size (D_{z} nanometres) and polydispersity shown in Table 37.

TABLE 37

| | |
|---|---|
| D_{z} (nm) | Pdl |

| Sample-surfactant | Day 1 | 48 hrs | Day 1 | 48 hrs |
|---|---|---|---|---|
| A - Genapol X020 | 220 | 215 | 0.135 | 0.165 |
| B - Genapol X050 | 175 | 180 | 0.123 | 0.162 |
| C -Genapol X060 | 180 | 180 | 0.180 | 0.203 |
| D -Genapol X080 | 215 | 190 | 0.278 | 0.173 |

### Part E—Using 2,4-D as the Sole Active

2,4-D was formed into a suspension concentrate of concentration 203 g/L g/Lin accordance with the general procedure of Example 20 using Pluronic F68 as the polymer and Genapol X050 as surfactant The resulting properties of the suspension concentrate are shown in Table provide a suspension concentrate having the particle size (D_{z} nanometres) and polydispersity shown in Table 38.

TABLE 38

| | D_{z} (nm) | | Pdl | |
|---|---|---|---|---|
| Sample | Day 1 | 24 hrs | Day 1 | 24 hrs |
| Pluronic F68/GenapolX050 | 170 | 160 | 0.408 | 0.367 |

### Example 22—Polymer/Surfactant Combinations (Multiple Active)

The process of Example 21 was repeated with a mixture of 2,4-D and MCPA in a weight ratio of 1.14:1. Two compositions were prepared with loadings of 100 g/L (reported as 1-5A) and 200 g/L (reported as 1-5B) respectively. Each of the loadings was prepared with the polymer/surfactant combination shown in Table 39.

TABLE 39

| Sample Number | Polymer | Surfactant |
|---|---|---|
| 1 | Pluronic F68 | Genapol X050 |
| 2 | Atlox Metasperse 550S | Genapol X050 |
| 3 | Pluronic F68 | Tween 24 |
| 4 | Atlox Metasperse 550S | Synperonic PE/L 64 |
| 5 | Pluronic F127 | Atlox 4916 |

The observed results are shown in Table 40.

| | D_{z} (nm) | Pdl |
|---|---|---|
| Sample | Day 1 | Day 1 |
| 1A | 150 | 0.242 |
| 2A | 110 | 0.279 |
| 3A | 530 | 0.659 |
| 4A | 120 | 0.332 |
| 5A | 205 | 0.277 |
| 1B | 235 | 0.324 |
| 2B | 130 | 0.230 |
| 3B | 125 | 0.370 |
| 4B | 130 | 0.387 |
| 5B | 275 | 0.280 |

### Example 23—Establishing the Hot Solution Temperatures

Numerous materials may act to form solutions of agrochemicals at elevated temperature. The solubility of MCPA, 2,4-D) and mecoprop with a range of common excipients was assessed at elevated temperature. To establish the melting behaviour of the individual actives, each active (1.25 g) was weighed into a 40 mL vial and heated gradually using a hotplate and Asynt heating insert until full melted, and the melting range was noted. The recorded temperature represented the temperature of the metal heating insert, and therefore does not represent the temperature of the active ingredient. To establish hot solvent behaviour, a range of excipients were weighed into 40 mL vials (0.676 g) with each chosen active (1.25 g). The mixtures were then heated gradually until a fully homogeneous solution was observed and the temperature was noted as described above. Additionally, the potential for agrochemicals to act as solvents for a second agrochemical at elevated temperature was also studied by combining the active ingredients in a ratio of 1.85:1 active:active ‘solvent’ following the same procedure as described above. For example, in a mixture where the first active was MCPA (1.25 g) and the second was mecoprop (0.676 g) both actives were added to a 40 mL vial and heated following the procedure detailed above. Where a homogeneous phase is observed below the measured melting point of the study active ingredient, a hot solution is considered to have been formed and the excipient is deemed to act as a solvent at elevated temperature.

The results (temperatures where a homogeneous solution was observed) for individual active agents is shown in Table 41. Where the “solvent” is listed as “None”, the temperature stated represents the formation of a homogeneous melt.

TABLE 41

| | Active ingredient temperature range where | | |
|---|---|---|---|
| | homogeneous solutions formed (° C.) | | |
| “Solvent” | MCPA | Mecoprop | 2,4-D |
| None | 132-135 | 99-101 | 148-150 |
| Glycerol | 100-102 | 77-78 | 116-118 |
| Propylene glycol | 86-87 | 60-64 | 110-112 |
| Dipropylene glycol dimethyl ether | 93-95 | 55-58 | 114-116 |
| 1,2-Propanediol | 86-87 | 60-64 | 110-112 |
| PEG 1000 | 106-108 | 77-78 | 124-126 |
| PEG 400 | 95-96 | 67-69 | 122-123 |
| Crodamol AB | 117-119 | 82-84 | 136-138 |
| Crodamol GTCC | 118-121 | 90-94 | 138-140 |
| PEG 4000 | 113-115 | 80-84 | 134-136 |
| Genapol X020 | 106-108 | 76-79 | 118-121 |
| Genapol X050 | 106-108 | 76-79 | 120-123 |
| Genapol X060 | 106-108 | 77-79 | 118-122 |
| Genapol X080 | 106-108 | 77-79 | 118-121 |
| Atlas G5000 | 111-113 | 89-91 | 129-131 |
| Multiwet MO85 | 125-128 | 85-92 | 140-143 |
| Atplus 245 | 106-108 | 76-79 | 123-126 |
| Synperonic PE/L31 | 110-111 | 82-84 | 129-130 |
| Synperonic PE/L64 | 111-113 | 87-88 | 132-135 |
| Atplus PFA | 110-112 | 79-82 | 127-130 |
| Atplus UEP | 111-114 | 83-85 | 132-135 |
| Synprolam 35X15 | 105-106 | 79-82 | 123-126 |
| Altox 4894 | 102-106 | 76-79 | 121-125 |
| Altox 4912 | 115-118 | 90-93 | 138-140 |
| Altox 4913 | 96-100 | 73-76 | 116-120 |
| Atlox 4914 | 118-119 | 90-92 | 138-137 |
| Atlox 4915 | 112-115 | 88-92 | 134-137 |
| Atlox 4916 | 118-119 | 93-95 | 140-141 |
| Tween 22 | 105-107 | 82-85 | 120-124 |
| Tween 23 | 105-107 | 82-84 | 120-124 |
| Tween 24 | 105-107 | 81-84 | 120-124 |
| Pluronic F127 | 116-119 | 89-92 | 137-140 |
| Pluronic F68 | 116-119 | 89-92 | 137-140 |

The results for combinations of actives in which a lower melting active is used as a solvent for higher melting active are shown in Table 42.

TABLE 42
Solution Formation Temperature (° C.)

| 1^{st} active | 2^{nd} active | |
|---|---|---|
| | | Melting range (° C.) |
| MCPA | — | 132-135 |
| Mecoprop | — | 99-101 |
| 2,4-D | — | 148-150 |
| Dichloroprop-P | — | 128-130 |
| | | Solution temp range |
| | | (° C.) |
| MCPA | Mecoprop | 112-115 |
| MCPA | 2,4-D | 130-132 |
| MCPA | Dichloroprop-P | 115-117 |
| Mecoprop | MCPA | 105-107 |
| Mecoprop | 2,4-D | 112-115 |
| Mecoprop | Dichloroprop-P | 112-115 |
| 2,4-D | MCPA | 140-142 |
| 2,4-D | Mecoprop | 130-131 |
| 2,4-D | Dichloroprop-P | 130-132 |

Suspension concentrates may be prepared by dispersing the combination of actives, in which the higher temperature melting active is dissolved in the liquid of lower melting point active, by high shear mixing of the solution (at a temperature specified) with an aqueous solution of polymer and surfactant having a lower temperature such as 5° C. to 40° C.

### Example 24—DSC Thermograms Showing the Impact of Heating and Cooling a Series of Formulations of MCPA

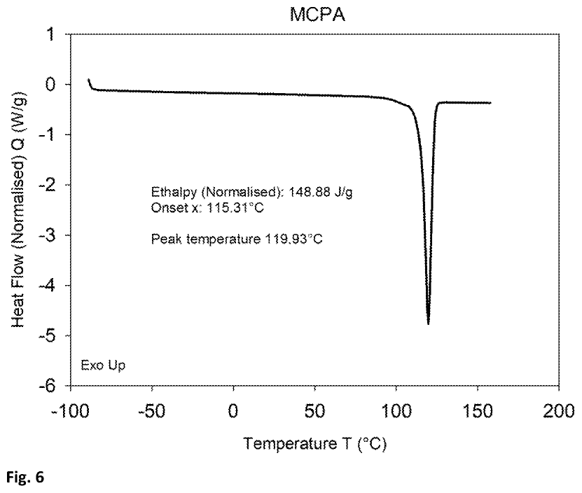

Experiments were conducted to examine the form of MCPA resulting from compositions and hot solutions including (a) MCPA as received from supplier; (b) MCPA melted, cooled and remelted; (c) MCPA hot solution in glycerol formed, precipitated and analysed; and (f) MCPA hot solution formed in GENAPOL X020 then precipitated and analysed. The results are shown in FIGS. 6 to 9 respectively.

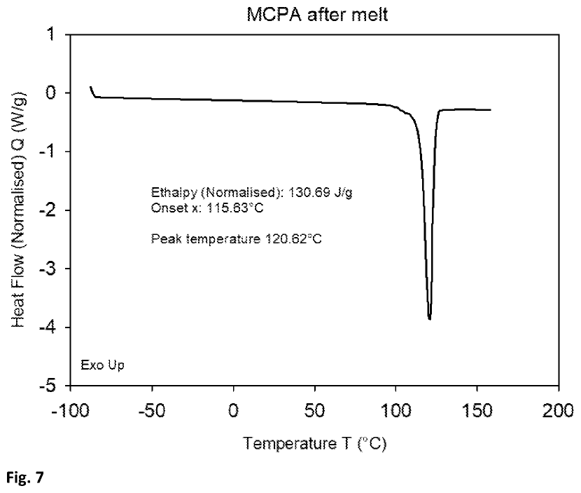

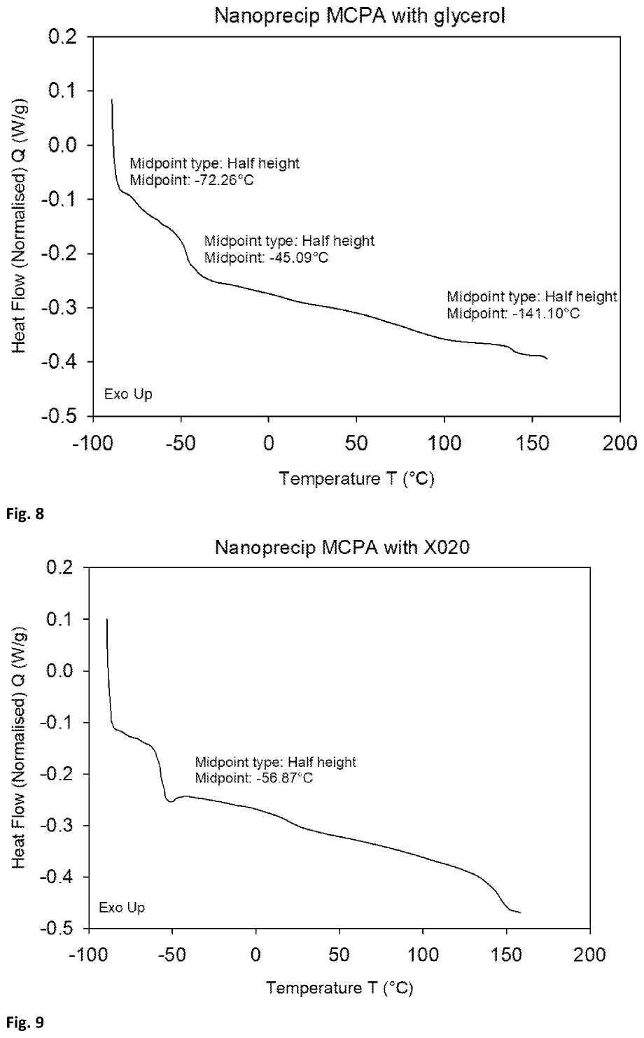

From FIG. 6 it can be seen that heating and cooling the compositions just leads to the same crystalline material FIGS. 6 and 7); heating to form a hot solution and allowing it to cool (in glycerol) was found to retain significant crystallinity, heating in glycerol to form a hot solution and then precipitating in an aqueous phase forms a product with no meaningful melting transition (FIG. 8) and the same thing happens if you switch glycerol for Genapol X020 (FIG. 9f).

### Example 25 Microparticles—Dichlorprop P (2,4-DP) Data Summary

This example compares the efficacy in glass house trials of a dichloprop suspension concentrate (“SC”) of the invention with a comparative solution concentrate of dichlorprop-P in the form of the dimethylamine (DMA) salt. The trials were conducted using each composition with and without a surfactant adjuvant (“surfactant”).

### Preparation of Suspension Concentrate (SC) Having a Concentration of 325 g/L

The 2,4-DP was dissolved in the surfactant Atlox® 4894 at a temperature of 115° C. and the solution was added to an aqueous phase solution of PVA and Genapol® X050 having a weight ratio of PVA:Genapol® X050 of 2:1 with the amount of the sum of these surfactants being 66 wt % with respect to the 2,4-DP active agent. The addition took place adjacent the underside of the high shear mixer The particle size of the resulting suspension was determined to be D90 0.2 to 0.3 micron.

### Results

The results of the glasshouse trials are shown in the following tables in which the following abbreviations are used in the table headings.
“SC” Composition Example_325 g/L 2,4-Dp—Microparticle formulation
“DMA Salt”—Comparative Example (a) 600 gae/L 2,4-Dp as the dimethyl amine salt formulation
Surfactant Genamin C050 at 125 ml/100 L spray mixture [PEG-5 Cocamine 900 g/kg] used at a concentration of 125 ml/100 L spray solution.
Compositions were applied at a rate of 50-1500 gae/ha
DAA refers to days after application of the composition.

Generally, the SC preparations performed similarly to the solution concentrates of the water-soluble DMA salt.

TABLE 43
Chenopodium album; - ANOVA Table, 23DAT Fresh weight (g)

| Rate (g ae/ha) | SC | | SC + surfactant | | DMA salt | | DMA salt + surfactant | |
|---|---|---|---|---|---|---|---|---|
| 50 | 21.11 | bc | 17.39 | cd | 24.01 | b | 16.53 | de |
| 100 | 17.33 | cd | 15.4 | d-g | 16.23 | def | 15.41 | d-g |
| 200 | 16.75 | cde | 14.55 | d- | 15.92 | def | 15.42 | d-g |
| 300 | 15.18 | d-g | 15.09 | d-h | 15.75 | def | 13.58 | d-j |
| 400 | 14.93 | d-h | 14.35 | d- | 14.72 | d-h | 13.54 | d-j |
| 600 | 13.98 | d-j | 13.36 | d-j | 13.64 | d-j | 13.3 | d-j |
| 900 | 13.53 | d-j | 12.48 | e-k | 13.55 | d-j | 9.87 | j-m |
| 1200 | 11.85 | f-k | 12.5 | e-k | 10.1 | i-m | 7.31 | lm |
| 1500 | 11.07 | g-l | 10.7 | h- | 8.12 | klm | 6.04 | m |
| UTC | 30.99 | a | | | | | | |
| UTC | 31.93 | a | | | | | | |
| LSD P = .05 (% mean diff) | 4.48 | | | | | | | |
| Treatment Prob(F) | 0.0001 | | | | | | | |

TABLE 44
FAOV Table-Chenopodium album - Fresh weight (g) 23DAA -

| SC | 15.08 a |
|---|---|
| SC + surfactant | 13.98 a |
| DMA salt | 14.67 a |
| DMA salt + surfactant | 12.33 b |
| LSD P = .05 | 1.52 |
| Prob(F) | 0.0024 |

Averaged across rates, SC+DMA formulations were equivalent when no surfactant added. There was no significant enhancement in efficacy with the addition of surfactant to the SC formulation but there was a significant enhancement in efficacy for the DMA formulation with the inclusion of surfactant.

TABLE 45
Helianthus annuus; Fresh weight (g) 18DAA

| Rate (g ae/ha) | SC | | SC + surfactant | | DMA salt | | DMA salt + surfactant | |
|---|---|---|---|---|---|---|---|---|
| 50 | 52.26 | c | 42.89 | d | 59.4 | b | 37.11 | ef |
| 100 | 39.45 | de | 32.63 | fg | 43.45 | d | 30.84 | gh |
| 200 | 33.29 | fg | 26.15 | h-k | 29.31 | ghi | 21.98 | kl |
| 300 | 28.07 | g-j | 24.8 | i-l | 23.57 | jkl | 20.16 | lm |
| 400 | 22.33 | kl | 22.17 | kl | 19.4 | lm | 16.01 | mno |
| 600 | 16.16 | mno | 16.39 | mn | 12.22 | nop | 11.66 | n-q |
| 900 | 10.82 | o-r | 10.64 | o-r | 5.34 | rs | 5.68 | rs |
| 1200 | 7.28 | p-s | 6.15 | qrs | 3.12 | s | 3.35 | s |
| 1500 | 5.4 | rs | 4.04 | S | 2.91 | s | 2.56 | s |
| UTC | 72.42 | a | | | | | | |
| UTC | 70.93 | a | | | | | | |
| LSD P = .05 (% mean diff) | 5.57 | | | | | | | |
| Treatment Prob(F) | 0.0001 | | | | | | | |

TABLE 46
FAOV Table- Helianthus annuus - Fresh
weight (g) 18DAA - Formulation

| SC | 23.9 a |
|---|---|
| SC + surfactant | 20.7 b |
| DMA salt | 22.1 b |
| DMA salt + surfactant | 16.6 c |
| LSD P = .05 | 1.64 |
| Prob(F) | 0.0001 |

Averaged across rates, SC formulation was less efficacious than DMA formulation whether surfactant was included or not. Surfactant significantly enhanced efficacy for both formulations. Overall, the DMA formulation was more efficacious than the SC formulation on Sunflower.

TABLE 47
ANOVA Table - Centaurea cyanus - Fresh weight (g) 23DAA

| Rate (g ae/ha) | SC | | SC + surfactant | | DMA salt | | DMA salt + surfactant | |
|---|---|---|---|---|---|---|---|---|
| 50 | 31.57 | b | 30.88 | b | 35.75 | a | 27.07 | cd |
| 100 | 29.56 | bc | 24.95 | d | 29.76 | bc | 14.19 | efg |
| 200 | 15.19 | ef | 16.42 | e | 12.02 | fg | 5.61 | i-m |
| 300 | 10.69 | gh | 7.41 | hij | 7.81 | hi | 4.01 | j-o |
| 400 | 7.16 | h-k | 6.08 | i-l | 2.94 | l-o | 3.17 | l-o |
| 600 | 3.7 | k-o | 5.12 | i-n | 3.1 | l-o | 2.37 | mno |
| 900 | 2.44 | mno | 2.78 | l-o | 1.89 | no | 1.72 | no |
| 1200 | 2.43 | mno | 2.11 | mno | 1.88 | no | 1.69 | no |
| 1500 | 2.82 | l-o | 2.6 | l-o | 1.88 | no | 1.27 | o |
| UTC | 38.09 | a | | | | | | |
| UTC | 37.17 | a | | | | | | |
| LSD P = .05 (% mean diff) | 3.60 | | | | | | | |
| Treatment Prob(F) | 0.0001 | | | | | | | |

TABLE 48
FAOV Table- Centaurea cyanus - Fresh
weight (g) 23DAA - Formulation

| SC | 11.7 a |
|---|---|
| SC + surfactant | 10.9 a |
| DMA salt | 10.8 a |
| DMA salt + surfactant | 6.8 b |
| LSD P = .05 | 1.20 |
| Prob(F) | 0.0001 |

Averaged across rates, SC+DMA formulations were equivalent when no surfactant added. There was no significant enhancement in efficacy with the addition of surfactant to the SC formulation but there was a significant enhancement in efficacy for the DMA formulation with the inclusion of surfactant.

TABLE 49
ANOVA Table - Brassica napus - Fresh weight (g) 23DAA

| Rate (g ae/ha) | SC | | SC + surfactant | | DMA salt | | DMA salt + surfactant | |
|---|---|---|---|---|---|---|---|---|
| 50 | 38.21 | c | 25.49 | d | 58.31 | b | 17 | ef |
| 100 | 20.16 | e | 14.55 | f | 55.18 | b | 7.4 | g |
| 200 | 9.07 | g | 6.13 | gh | 17.15 | ef | 7.05 | g |
| 300 | 6.54 | g | 3.02 | hi | 9.03 | g | 2.62 | i |
| 400 | 2.16 | i | 2.07 | i | 2.71 | i | 1.47 | i |
| 600 | 1.66 | i | 1.64 | i | 1.59 | i | 1.09 | i |
| 900 | 1.24 | i | 1.23 | i | 1.19 | i | 0.68 | i |
| 1200 | 1 | i | 0.88 | i | 0.92 | i | 0.63 | i |
| 1500 | 0.71 | i | 0.61 | i | 0.66 | i | 0.31 | i |
| UTC | 70.85 | a | | | | | | |
| UTC | 69.27 | a | | | | | | |
| LSD P = .05 (% mean diff) | 3.41 | | | | | | | |
| Treatment Prob(F) | 0.0001 | | | | | | | |

TABLE 50
FAOV Table- Brassica napus - Fresh
weight (g) 23DAA - Formulation

| SC | 9.0 b |
|---|---|
| SC + surfactant | 6.2 c |
| DMA salt | 16.3 a |
| DMA salt + surfactant | 4.3 d |
| LSD P = .05 | 1.01 |
| Prob(F) | 0.0001 |

Averaged across rates, SC formulation was significantly more efficacious than DMA formulation in the absence of surfactant and DMA formulation was significantly more efficacious than SC formulation when applied with surfactant. The addition of surfactant significantly enhanced efficacy on both formulations.

TABLE 51
Table ANOVA Table - Papaver rhoeas - Fresh weight (g) 23DAA

| Rate (g ae/ha) | SC | | SC + surfactant | | DMA salt | | DMA salt + surfactant | |
|---|---|---|---|---|---|---|---|---|
| 50 | 12.35 | cd | 11.3 | cde | 20.42 | b | 12.38 | cd |
| 100 | 8.06 | e-i | 10.58 | def | 14.77 | c | 12.24 | cd |
| 200 | 7.55 | f-j | 8.8 | d-h | 14.76 | c | 7.07 | f-j |
| 300 | 5.96 | h-n | 6.62 | g-k | 9.78 | d-g | 6.03 | h-m |
| 400 | 4.82 | i-o | 4.76 | i-o | 9.53 | d-h | 4.67 | i-o |
| 600 | 2.82 | l-p | 2.62 | l-p | 6.13 | h-l | 2.4 | nop |
| 900 | 1.94 | op | 2.61 | l-p | 2.49 | m-p | 1.3 | op |
| 1200 | 1.78 | op | 2.53 | l-p | 4 | j-p | 1.54 | op |
| 1500 | 1.28 | op | 2.41 | nop | 3.4 | k-p | 0.53 | p |
| UTC | 29 | a | | | | | | |
| UTC | 30.29 | a | | | | | | |
| LSD P = .05 (% mean diff) | 3.61 | | | | | | | |
| Treatment Prob(F) | 0.0001 | | | | | | | |

TABLE 52
FAOV Table- Papaver rhoeas - Fresh
weight (g) 23DAA - Formulation

| SC | 5.2 b |
|---|---|
| SC + surfactant | 5.8 b |
| DMA salt | 9.5 a |
| DMA salt + surfactant | 5.4 b |
| LSD P = .05 | 1.218 |
| Prob(F) | 0.0001 |

Averaged across rates, SC formulation was more efficacious than DMA formulation when no surfactant included in the spray mixture. There was no significant enhancement in efficacy with the addition of surfactant to the SC formulation but there was a significant enhancement in efficacy for the DMA formulation with the inclusion of surfactant. The two formulations were equivalent when surfactant was added to the spray mixture.

1. A method of preparing an herbicidal carboxylic acid aqueous suspension comprising
providing a liquid composition of a carboxylic acid herbicide in the form of a solution comprising a solvent for the carboxylic acid herbicide;
combining the liquid composition with an aqueous phase precipitant having a temperature less than the melting point of the carboxylic acid herbicide, optionally in the presence of one or more of a water-soluble polymer and surfactant, under conditions of high shear mixing to cause the solution to precipitate the carboxylic acid herbicide from the solution into the aqueous phase and form a suspension concentrate of the carboxylic acid herbicide.

2. The method of claim 1, wherein the carboxylic acid herbicide precipitate is formed in the suspension concentrate in an amount of at least 200 g/L.

3. The method of claim 1, wherein the solvent is selected from surfactants, organic solvent for the carboxylic acid herbicide and mixtures thereof.

4. (canceled)

5. The method of claim 1, wherein the solvent is non-volatile solvent.

6. The method of claim 1, wherein the solvent for the carboxylic acid herbicide is at least one selected from the group consisting of C₂ to C₆ glycols, glycerol and mono- and di-C₁ to C₁₈ aliphatic esters thereof, organic acids, N,N-dimethylformamide, mono esters of glycols, polyethers C₁ to C₄ alkyl ethers of ethylene glycol and diethylene glycol, C₁ to C₄ ethers of propylene glycol and di-propylene glycol, and surfactants.

7. The method of claim 1, wherein the solvent for the carboxylic acid herbicide comprises at least one selected from the group consisting of propylene glycol, glycerol, di- and poly-alkylene glycols, polyols, and surfactants selected from the group consisting of alkoxylated fatty alcohols, alkoxylated alkyphenols, polysorbates, poloxamers, alkoxylated fatty alkyl esters and polyoxyethylene/polyoxypropylene block copolymers.

8-9. (canceled)

10. The method of claim 1, wherein the surfactant is present and is a fatty alcohol alkoxylate.

11. (canceled)

12. The method of claim 1, wherein the solvent is a non-volatile solvent and the carboxylic acid herbicide is dissolved in the non-volatile solvent at an elevated temperature of at least 60° C. to form a hot solution of the carboxylic acid herbicide which is combined at a temperature less than the melting point of the carboxylic acid herbicide with the aqueous phase with high shear to precipitate particles of the carboxylic acid herbicide.

13. The method of claim 1, wherein the solution of the carboxylic acid herbicide is introduced to the aqueous phase within the aqueous phase and in a zone of high shear mixing.

14. The method of claim 1, wherein the carboxylic acid herbicide comprises at least one selected from the group consisting of phenoxy carboxylic acids, aryloxy-phenoxy carboxylic acids, benzoic acids, pyridine carboxylic acids, pyridyloxy carboxylic acids quinoline carboxylic acids, pyrimidine carboxylic acids, arylpyridine carboxylic acids and organophosphorus carboxylic acid herbicides.

15. (canceled)

16. The method of claim 12, wherein the carboxylic acid herbicide is poorly soluble in the solvent at 20° C., having a solubility of no more than 5 g/L and is soluble at the elevated temperature in an amount of at least 20 g/L.

17. The method of claim 1, wherein the liquid composition is at a temperature no cooler than 30° C. below the melting point of the carboxylic acid herbicide when combined with the aqueous phase and wherein the aqueous phase is at a temperature of from 5° C. to 50° C.

18. (canceled)

19. The method of claim 1, wherein the water-soluble polymer is present and selected from polyvinyl pyrrolidone, polyvinyl alcohol and polyethylene glycol.

20-22. (canceled)

23. The method of claim 1, wherein the suspension of particulate carboxylic acid herbicide is precipitated in the form of particles of carboxylic acid herbicide which are predominantly amorphous.

24. The method of claim 1, wherein the solution of the carboxylic acid herbicide comprises a solvent which is a solid at ambient temperature and provides a solvent for the carboxylic acid herbicide at elevated temperature and the method comprises forming the liquid solution at the elevated temperature and combining the liquid at the elevated temperature with the aqueous phase at a temperature no more than 60° C. to precipitate the carboxylic acid herbicide.

25. The method of claim 24, wherein the liquid solution composition comprises a plurality of active agents comprising a carboxylic acid herbicide and at least one further agrichemical active agent selected from the group consisting of:
herbicides,
fungicides,
insecticides,
plant growth regulators,
nematicides, and
fertilisers.

26. (canceled)

27. The method of claim 25, wherein the agrichemical active is solid at ambient temperature and provides the solvent at a lower temperature than the melting point of the carboxylic acid herbicide and the method comprises forming the liquid solution at the elevated temperature and combining the liquid at the elevated temperature with the aqueous phase wherein the aqueous phase has a temperature no more than 60° C. and less than the solidification temperature of the agrichemical active to precipitate the carboxylic acid herbicide and the agrichemical active.

28-32. (canceled)

33. The method of claim 1, wherein the particles of carboxylic acid herbicide are of size, (D_{z}), of no more 0.8 microns; and have a polydispersity index (PdI) of no more than 0.6.

34. A herbicidal aqueous suspension concentrate comprising a solid particle suspension of at least one carboxylic acid herbicide in an amount of at least 10 g/L of suspension concentrate and a surfactant wherein the particles of carboxylic acid herbicide are of size, (D_{z}), of no more 0.5 micron and a polydispersity index (PdI) of no more than 0.6.

35. (canceled)

36. The herbicidal aqueous suspension concentrate of claim 34, wherein the suspension of particulate carboxylic acid herbicide is predominantly amorphous.

37-41. (canceled)
